(19) United States
(12) Patent Application Publication
(10) Pub. No.: US 2016/0114335 A1
(43) Pub. Date: Apr. 28, 2016

(54) METHODS AND COLLECTORS FOR PURIFYING PHOSPHOROUS CONTAINING MATERIALS

(71) Applicant: Georgia-Pacific Chemicals LLC, Atlanta, GA (US)

(72) Inventor: David R. Snead, Atlanta, GA (US)

(73) Assignee: GEORGIA-PACIFIC CHEMICALS LLC, Atlanta, GA (US)

(21) Appl. No.: 14/920,848

(22) Filed: Oct. 22, 2015

Related U.S. Application Data
(60) Provisional application No. 62/067,680, filed on Oct. 23, 2014.

(51) Int. Cl. B03D 1/008; B03D 1/02

(52) U.S. Cl. CPC B03D 1/008; B03D 1/021

(57) ABSTRACT

Compositions, aqueous mixtures that include the composition and an ore, and methods for making and using same are provided. The composition can include a tall oil and a saccharide-based monoester that can have the chemical formula (A). The aqueous mixture can include an ore, water, the tall oil, and the saccharide-based monoester that can have the chemical formula (A). The method can include combining the ore, water, the tall oil, and the saccharide-based monoester that can have the chemical formula (A) to produce an aqueous mixture. The method can also include collecting a purified ore from the aqueous mixture. In the chemical formula (A), R¹ can be a saccharide group having 1 to 14 hydroxyl groups and R² can be a C9 to C24 chain having 1 to 5 unsaturated bonds.

### CROSS-REFERENCE TO RELATED APPLICATION

This application claims priority to U.S. Provisional Patent Application No. 62/067,680, filed on Oct. 23, 2014, which is incorporated by reference herein.

### BACKGROUND

1. Field

Embodiments described generally relate to collectors for purifying an ore. More particularly, such embodiments relate to collectors, aqueous mixtures that include the collector and an ore, and methods for making and using same.

2. Description of the Related Art

Froth flotation is a method that uses the differences in the hydrophobicity of the mineral particles to be separated or purified from aqueous slurries containing the mineral particles and one or more impurities. Certain heteropolar or nonpolar chemicals called collectors are typically added to the aqueous slurries to enhance or form water repellencies on the surfaces of the mineral particles. These collectors are designed to selectively attach to one or more of the mineral particles to be separated and form a hydrophobic monolayer on the surfaces of the mineral particles. The formation of the hydrophobic monolayer lowers the surface energy of the mineral particles, which increases the chance that the particles will bind with air bubbles passing through in the slurry. The density of the combined air bubble and mineral particles is less than the displaced mass of the aqueous slurry, which causes the air bubble and mineral particles to float to the surface of the slurry. A mineral-rich froth is formed by the collection of the floating air bubble and mineral particles at the surface of the slurry that can be skimmed off from the surface, while other minerals or material, e.g., impurities, remain submerged and/or flocculated in the slurry.

Phosphorus ores generally contain impurities and phosphate materials, e.g., calcium phosphate that can be represented by the general chemical formula Ca₅(PO₄)₃(X), where X can be fluoride, chloride, and/or hydroxide. Phosphate materials, such as calcium phosphate, generally have a polar, hydrophilic surface. Many of the impurities in the phosphorous ore also have polar, hydrophilic surfaces and are not easy to selectively separate from the phosphate materials. Conventional collectors in phosphate beneficiation, such as polysorbate and sodium dodecylbenzenesulfonate (SDBS), are generally hydrophilic collectors with relatively high hydrophilic lipophilic balance (HLB) values. For example, polysorbate 80 has an HLB value of about 15 and SDBS has an HLB value of about 30. These conventional collectors can exhibit inadequate results with respect to selectivity and yield of phosphate material relative to the impurities in the phosphorous ore.

There is a need, therefore, for improved collectors for purifying ores, e.g., phosphorus ores, and methods for making and using same.

### SUMMARY

Compositions, aqueous mixtures that include the composition and an ore, and methods for making and using same are provided. In one or more embodiments, the composition can include a tall oil and a saccharide-based monoester. The saccharide-based monoester can have the chemical formula:

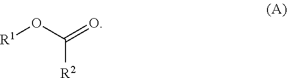

In the chemical formula (A): R¹ can be a saccharide group having 1 to 14 hydroxyl groups and R² can be a C9 to C24 chain having 1 to 5 unsaturated bonds.

In one or more embodiments, the aqueous mixture can include water, an ore, a tall oil, and a saccharide-based monoester. The saccharide-based monoester can have the chemical formula (A). In the chemical formula (A): R¹ can be a saccharide group having 1 to 14 hydroxyl groups, and R² can be a C9 to C24 chain having 1 to 5 unsaturated bonds.

In one or more embodiments, a method for purifying an ore can include combining an ore, water, a tall oil, and a saccharide-based monoester to produce an aqueous mixture. The saccharide-based monoester can have the chemical formula (A). In the chemical formula (A): R¹ can be a saccharide group having 1 to 14 hydroxyl groups and R² can be a C9 to C24 chain having 1 to 5 unsaturated bonds. A purified ore can be collected from the aqueous mixture.

### DETAILED DESCRIPTION

It has been surprisingly and unexpectedly discovered that mixing, blending, or otherwise combining one or more tall oils and one or more saccharide-based monoesters, e.g., sorbitan monoesters, can produce a composition or collector that can significantly improve impurity flotation in the beneficiation of an ore, e.g., phosphorous ore. Surprisingly, the mixture or blend of the one or more tall oils and the one or more sorbitan monoesters provides a synergetic effect and performs better as a flotation agent, e.g., greater selectivity to and/or yield of phosphate, as compared to the tall oil or the sorbitan monoester alone. Also surprising, compositions or collectors containing hydrophobic sorbitan monooleate performed better in the rougher floats for phosphate beneficiation than did compositions or collectors containing hydrophilic polysorbate 80. Without wishing to be bound by theory, it is believed that the mixture or blend of the tall oil and the sorbitan monoester can provide enhanced adhesion to the surface of the ore that lowers the surface energy, which increases the likelihood for the ore to bind or otherwise attract to air bubbles and thus increase the buoyancy of the ore. Accordingly, in one or more examples, one or more ores, e.g., a phosphorous ore, one or more tall oils, and one or more saccharide-based monoesters can be mixed, blended, or otherwise combined with one another to produce an aqueous mixture and a purified ore can be separated, recovered, or otherwise collected from the aqueous mixture.

The saccharide-based monoester can be or include one or more esters having the chemical formula:

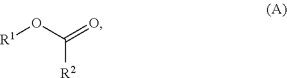

where R¹ can be a saccharide group having 1 to 14 hydroxyl groups, and R² can be or include a saturated or unsaturated, substituted or unsubstituted, linear or branched, cyclic, heterocyclic, or aromatic hydrocarbyl group, such as, but not limited to, a C3 to C70 chain, a C5 to C30 chain, a C7 to C28 chain, a C9 to C24 chain, a C11 to C24 chain, a C13 to C22 chain, or a C15 to C18 chain. In some specific examples, R² can be or include a C9 to C24 chain having 1 to 5 unsaturated bonds or a C15 to C18 chain having 1 to 4 unsaturated bonds. The ore can be or include a phosphorous ore that includes a phosphate material and one or more impurities or gangue materials. The purified ore collected or recovered from the aqueous mixture can include less of the one or more impurities or gangue materials as compared to the ore.

The saccharide group can be formed, derived, or otherwise produced from one or more saccharides that can include, but is not limited to, monosaccharides, disaccharides, polysaccharides, celluloses, starches, or isomers thereof. The saccharide group R¹ can be bonded to the remaining portion of the saccharide-based monoester by a linking oxygen that can be derived from the base saccharide or from the “R²CO₂” fragment of the saccharide-based monoester having chemical formula (A). For example, the saccharide group R¹ can be a saccharide that is missing one hydrogen on a hydroxyl group, therefore the linking oxygen is derived from the base saccharide. In another example, the saccharide group R¹ can be a saccharide that is missing one hydroxyl group, therefore the linking oxygen is derived from the “R²CO₂” fragment of saccharide-based monoester. In some examples, the saccharide-based monoester having the chemical formula (A), with the exception to the “R¹CO₂R²” ester group, is substantially free or completely free of any other ester groups on the saccharide group. In other examples, the saccharide-based monoester having the chemical formula (A) is substantially free or completely free of polyalkyleneoxides on the saccharide group.

In some examples, R¹ can be or include a monosaccharide group. The monosaccharide group can be formed, derived, or otherwise produced from the respective monosaccharide. Illustrative monosaccharides that can be used to form, derive, or otherwise produce monosaccharide groups can be or include, but are not limited to, fructose (levulose), galactose, glucose (dextrose), mannose, ribose, sorbose, xylose, isomers thereof, or any mixture thereof. R¹ can be a monosaccharide group that can have 1 hydroxyl group to about 8 hydroxyl groups, 1 hydroxyl group to about 6 hydroxyl groups, 1 hydroxyl group to about 5 hydroxyl groups, 1 hydroxyl group to about 4 hydroxyl groups, 1 hydroxyl group to about 3 hydroxyl groups, or 1 hydroxyl group to about 2 hydroxyl groups. For example, R¹ can be a fructose or levulose group, a galactose group, a glucose or dextrose group, a mannose group, or a sorbose group and can have 1 hydroxyl group to about 4 hydroxyl groups since each of these base monosaccharides have 5 hydroxyl groups. In another example, R¹ can be a ribose group or a xylose group and can have 1 hydroxyl group to about 3 hydroxyl groups since each of these base monosaccharides have 4 hydroxyl groups.

In other examples, R¹ can be or include a disaccharide group that can have 1 hydroxyl group to about 10 hydroxyl groups. Disaccharide groups can be formed, derived, or otherwise produced from the respective disaccharide. Exemplary disaccharides that can be used to form, derive, or otherwise produce disaccharide groups can be or include, but are not limited to, sucrose, lactose, maltose, isomers thereof, or any mixture thereof. R¹ can be a disaccharide group that can have 1 hydroxyl group to about 10 hydroxyl groups, 1 hydroxyl group to about 8 hydroxyl groups, 1 hydroxyl group to about 6 hydroxyl groups, 1 hydroxyl group to about 5 hydroxyl groups, 1 hydroxyl group to about 4 hydroxyl groups, 1 hydroxyl group to about 3 hydroxyl groups, or 1 hydroxyl group to about 2 hydroxyl groups. For example, R¹ can be a sucrose group, a lactose group, or a maltose group and can have 1 hydroxyl group to about 8 hydroxyl groups since each of these base disaccharides have 8 hydroxyl groups.

In other examples, R¹ can be or include a saccharide group that can be formed, derived, or otherwise produced from one or more furanoses, one or more pyranoses, one or more polysaccharides, one or more celluloses, one or more starches, or isomers thereof. The furanoses and the pyranoses can be monosaccharides, disaccharides, or polysaccharides. The saccharide group, regardless of the base saccharide or other compound from which the saccharide group was formed, derived, or otherwise produced, can have one or multiple hydroxyl groups thereon. The saccharide group can have 1 hydroxyl group to about 16 hydroxyl groups, 1 hydroxyl group to about 14 hydroxyl groups, 1 hydroxyl group to about 12 hydroxyl groups, 1 hydroxyl group to about 10 hydroxyl groups, 1 hydroxyl group to about 8 hydroxyl groups, 1 hydroxyl group to about 6 hydroxyl groups, 1 hydroxyl group to about 5 hydroxyl groups, 1 hydroxyl group to about 4 hydroxyl groups, 1 hydroxyl group to about 3 hydroxyl groups, or 1 hydroxyl group to about 2 hydroxyl groups. In some examples, each R¹ can be a saccharide group that is substantially free or completely free of esters or polyalkyleneoxides.

In one or more examples, the saccharide-based monoester can be or include one or more sorbitan monoesters, and the sorbitan monoester can be or include one or more esters having the chemical formula:

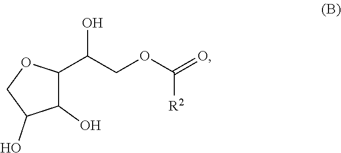

where R² is defined as above for the chemical formula (A). In some examples, R² can be or include a C9 to C24 chain having 1 to 5 unsaturated bonds or a C15 to C18 chain having 1 to 4 unsaturated bonds.

At least a portion of the impurities or gangue materials can be removed via froth flotation and the purified ore can be removed from or as a bottoms fraction. In the context of beneficiating or purifying a phosphorous ore, the collected and purified phosphate material can be about 85 wt % to about 99.9 wt % of a total phosphate material contained in the phosphorous ore. In some examples, the collected and purified phosphate material can be about 90 wt % to about 99.9 wt % of the total phosphate material contained in the phosphorous ore. For example, the collected and purified phosphate material can be about 95 wt % to about 99.9 wt %, about 97 wt % to about 99.9 wt %, or about 98 wt % to about 99.9 wt % of the total phosphate material contained in the phosphorous ore. In other examples, the collected and purified phosphate material can be at least 85 wt %, at least 90 wt %, at least 95 wt %, at least 96 wt %, at least 97 wt %, at least 97.5 wt %, or at least 98 wt % to about 99 wt %, about 99.3 wt %, about 99.5 wt %, about 99.7 wt %, or about 99.9 wt % of the total phosphate material contained in the phosphorous ore.

In some examples, one or more tall oils and one or more saccharide-based monoesters, e.g., sorbitan monoesters, can be mixed, blended, or otherwise combined to produce a tall oil-saccharide monoester composition or collector, e.g., a tall oil-sorbitan ester composition or collector. The tall oil-saccharide monoester composition or collector can be mixed, blended, or otherwise combined with the ore, e.g., a phosphorous ore, to produce the aqueous mixture. Water can be added to or can be combined with the tall oil-saccharide monoester composition or collector, the tall oil, the saccharide-based monoester, the ore, the aqueous mixture, or any mixture thereof. In some examples, the tall oil-saccharide monoester composition or collector can include about 80 wt % to about 99.5 wt % of the tall oil and about 0.5 wt % to about 25 wt % of the saccharide-based monoester, based on the combined weight of the tall oil and the saccharide-based monoester. The aqueous mixture can include about 0.01 wt % to about 5 wt % or about 0.05 wt % to about 0.5 wt % of the tall oil-saccharide monoester composition or collector, based on the weight of the ore.

The aqueous mixture can be agitated by passing gas bubbles, e.g., air bubbles, through the aqueous mixture, mechanically stirring, e.g., impeller, paddle, stirrer, shaking, directing sound waves, e.g., ultrasonic sound waves, into the aqueous mixture, or otherwise moving the aqueous mixture, or any combination thereof. The aqueous mixture can be an aqueous solution, slurry, suspension, dispersion, or the like. When the ore includes a phosphorous ore, the phosphorous or phosphate containing ores, rocks, minerals, or other materials, as well as the recovered or collected phosphate materials can include one or more tribasic phosphate salts. The tribasic phosphate salts can include alkaline earth metals, alkali metals, adducts thereof, complexed salts thereof, hydrates thereof, or any mixture thereof. In one example, the phosphorous ore or the phosphate material can include calcium phosphate.

In one or more examples, the aqueous mixture can include an ore, water, a tall oil, and one or more saccharide-based monoesters that can include one or more esters having the chemical formula (A), where R¹ can be a saccharide group having 1 to 14 hydroxyl groups, and R² can be a C9 to C24 chain having 1 to 5 unsaturated bonds. In some examples, the ore can be or include a phosphorous ore that can be or include calcium phosphate, R¹ can be a monosaccharide group having 1 to 4 hydroxyl groups or a disaccharide group having 1 to 7 hydroxyl groups, R² can be a C15 to C17 chain having 1 to 3 unsaturated bonds, and the aqueous mixture can include about 0.1 wt % to about 0.6 wt % of the tall oil and about 0.003 wt % to about 0.054 wt % of the saccharide-based monoester, based on the weight of the ore.

In other examples, the aqueous mixture can include an ore, water, a tall oil, and a sorbitan monoester, where the sorbitan monoester can include one or more esters having the chemical formula (B), where R² can be a C15 to C18 chain having 1 to 4 unsaturated bonds. In some examples, the ore can be or include a phosphorous ore that can be or include calcium phosphate, the R² can be a C15 to C17 chain having 1 to 3 unsaturated bonds, and the aqueous mixture can include about 0.1 wt % to about 0.6 wt % of the tall oil and about 0.003 wt % to about 0.054 wt % of the sorbitan monoester, based on the weight of the ore.

The amount of the tall oil in the aqueous mixture can be about 0.005 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 9 wt %, or about 10 wt %, based on the weight of the ore, e.g., a phosphorous ore. In some examples, the amount of the tall oil in the aqueous mixture can be about 0.005 wt % to about 15 wt %, about 0.01 wt % to about 10 wt %, about 0.01 wt % to about 8 wt %, about 0.01 wt % to about 6 wt %, about 0.01 wt % to about 5 wt %, about 0.01 wt % to about 4 wt %, about 0.01 wt % to about 3 wt %, about 0.01 wt % to about 2 wt %, about 0.01 wt % to about 1 wt %, about 0.1 wt % to about 8 wt %, about 0.1 wt % to about 6 wt %, about 0.1 wt % to about 5 wt %, about 0.1 wt % to about 4 wt %, about 0.1 wt % to about 3 wt %, about 0.1 wt % to about 2 wt %, about 0.1 wt % to about 1 wt %, about 0.1 wt % to about 0.9 wt %, about 0.1 wt % to about 0.8 wt %, about 0.1 wt % to about 0.7 wt %, about 0.1 wt % to about 0.6 wt %, about 0.1 wt % to about 0.5 wt %, or about 0.1 wt % to about 0.4 wt %, based on the weight of the phosphorous ore. In one specific example, the amount of the tall oil in the aqueous mixture can be about 0.2 wt % to about 0.4 wt %, based on the weight of the ore.

The amount of the saccharide-based monoester, e.g., sorbitan monoester, in the aqueous mixture can be about 0.0005 wt %, about 0.001 wt %, about 0.0015 wt %, about 0.002 wt %, about 0.0025 wt %, about 0.003 wt %, about 0.0035 wt %, about 0.004 wt %, about 0.0045 wt %, about 0.005 wt %, about 0.0055 wt %, about 0.006 wt %, about 0.0065 wt %, about 0.007 wt %, about 0.0075 wt %, about 0.008 wt %, about 0.0085 wt %, about 0.009 wt %, about 0.0095 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.3 wt %, about 0.5 wt %, or about 1 wt %, based on the weight of the ore, e.g., a phosphorous ore. In some examples, the amount of the saccharide-based monoester, e.g., sorbitan monoester, in the aqueous mixture can be about 0.0005 wt % to about 1 wt %, about 0.0005 wt % to about 0.1 wt %, about 0.0005 wt % to about 0.15 wt %, about 0.001 wt % to about 0.1 wt %, about 0.001 wt % to about 0.09 wt %, about 0.001 wt % to about 0.06 wt %, about 0.002 wt % to about 0.06 wt %, about 0.003 wt % to about 0.06 wt %, about 0.003 wt % to about 0.054 wt %, or about 0.004 wt % to about 0.05 wt %, based on the weight of the phosphorous ore. In one specific example, the amount of the saccharide-based monoester, e.g., sorbitan monoester, in the aqueous mixture can be about 0.005 wt % to about 0.03 wt %, based on the weight of the ore.

In some examples, the aqueous mixture can include about 0.1 wt % to about 0.6 wt % of the tall oil and about 0.003 wt % to about 0.054 wt % of the saccharide-based monoester, e.g., sorbitan monoester, based on the weight of the ore, e.g., a phosphorous ore. In other examples, the aqueous mixture can include about 0.2 wt % to about 0.4 wt % of the tall oil and about 0.005 wt % to about 0.03 wt % of the saccharide-based monoester, e.g., sorbitan monoester, based on the weight of the ore.

In one or more examples, the amount of the tall oil in the composition or collector can be about 50 wt %, about 60 wt %, about 70 wt %, about 75 wt %, about 80 wt %, about 85 wt %, or about 90 wt % to about 91 wt %, about 92 wt %, about 93 wt %, about 94 wt %, about 95 wt %, about 96 wt %, about 97 wt %, about 97.5 wt %, about 98 wt %, about 98.5 wt %, about 99 wt %, about 99.5 wt %, about 99.7 wt %, or about 99.9 wt % based on the combined weight of the tall oil and the saccharide-based monoester. In some examples, the amount of the tall oil in the composition or collector can be about 50 wt % to about 99.5 wt %, about 60 wt % to about 99.5 wt %, about 70 wt % to about 99.5 wt %, about 80 wt % to about 99.5 wt %, about 90 wt % to about 99.5 wt %, about 90 wt % to about 99 wt %, about 95 wt % to about 99.5 wt %, about 90 wt % to about 98 wt %, or about 90 wt % to about 95 wt %, based on the combined weight of the tall oil and the saccharide-based monoester.

The amount of the saccharide-based monoester, e.g., sorbitan monoester, in the composition or collector can be about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, or about 8 wt % to about 8.5 wt %, about 9 wt %, about 9.5 wt %, about 10 wt %, about 15 wt %, about 20 wt %, about 25 wt %, about 30 wt %, about 40 wt %, or about 50 wt %, based on the combined weight of the tall oil and the saccharide-based monoester. In some examples, the amount of the saccharide-based monoester in the composition or collector can be about 0.1 wt % to about 40 wt %, about 0.1 wt % to about 30 wt %, about 0.2 wt % to about 25 wt %, about 0.5 wt % to about 25 wt %, about 0.5 wt % to about 20 wt %, about 0.5 wt % to about 15 wt %, about 0.5 wt % to about 12 wt %, about 0.5 wt % to about 10 wt %, about 0.5 wt % to about 9 wt %, about 0.5 wt % to about 5 wt %, about 0.9 wt % to about 20 wt %, about 1 wt % to about 25 wt %, about 1 wt % to about 20 wt %, about 1 wt % to about 15 wt %, about 1 wt % to about 12 wt %, about 1 wt % to about 10 wt %, about 1 wt % to about 9 wt %, or about 1 wt % to about 5 wt %, based on the combined weight of the tall oil and the saccharide-based monoester. In one specific example, the composition or collector can include about 75 wt % to about 99.5 wt % of the tall oil and about 0.5 wt % to about 25 wt % of the saccharide-based monoester, based on the combined weight of the tall oil and the saccharide-based monoester. In another specific example, the composition or collector can include about 80 wt % to about 99.5 wt % of the tall oil and about 0.5 wt % to about 20 wt % of the saccharide-based monoester, based on the combined weight of the tall oil and the saccharide-based monoester.

The amount of the composition or collector in the aqueous mixture can be about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.5 wt %, about 2 wt %, about 2.5 wt %, about 3 wt %, about 3.5 wt %, about 4 wt %, about 4.5 wt %, or about 5 wt %, based on the weight of the phosphorous ore. In other examples, the amount of the composition or collector in the aqueous mixture can be 0.01 wt % to about 5 wt %, 0.05 wt % to about 5 wt %, 0.1 wt % to about 5 wt %, about 0.01 wt % to about 0.5 wt %, about 0.02 wt % to about 0.5 wt %, about 0.03 wt % to about 0.5 wt %, about 0.04 wt % to about 0.5 wt %, or about 0.05 wt % to about 0.5 wt % of the composition or collector, based on the weight of the phosphorous ore.

In one specific example, the aqueous mixture can include about 0.01 wt % to about 5 wt % of the composition or collector, based on the weight of the phosphorous ore. In another specific example, the aqueous mixture can include about 0.05 wt % to about 1 wt % of the composition or collector, based on the weight of the phosphorous ore. In another specific example, the aqueous mixture can include about 0.08 wt % to about 0.8 wt % of the composition or collector, based on the weight of the phosphorous ore. In another specific example, the aqueous mixture can include about 0.1 wt % to about 0.5 wt % of the composition or collector, based on the weight of the phosphorous ore.

In one or more examples, the phosphate material that is recovered, collected, or otherwise purified from the aqueous mixture can be compared to the initial or total amount of the phosphate material contained in the phosphorous ore. For example, the purified phosphate material can be about 90 wt %, about 91 wt %, about 92 wt %, about 93 wt %, about 94 wt %, about 95 wt %, about 96 wt %, about 97 wt %, about 97.1 wt %, about 97.2 wt %, about 97.3 wt %, about 97.4 wt %, about 97.5 wt %, about 97.6 wt %, about 97.7 wt %, about 97.8 wt %, or about 97.9 wt %, about 98 wt %, about 98.1 wt %, about 98.2 wt %, about 98.3 wt %, about 98.4 wt %, about 98.5 wt %, about 98.6 wt %, about 98.7 wt %, about 98.8 wt %, about 98.9 wt %, about 99 wt %, about 99.1 wt %, about 99.2 wt %, about 99.3 wt %, about 99.4 wt %, about 99.5 wt %, about 99.6 wt %, about 99.7 wt %, about 99.8 wt %, or about 99.9 wt % of the total phosphate material contained in the phosphorous ore. In other examples, the purified phosphate material can be about 90 wt % to about 99.9 wt %, about 91 wt % to about 99.9 wt %, about 92 wt % to about 99.9 wt %, about 93 wt % to about 99.9 wt %, about 94 wt % to about 99.9 wt %, about 95 wt % to about 99.9 wt %, about 96 wt % to about 99.9 wt %, about 97 wt % to about 99.9 wt %, about 98 wt % to about 99.9 wt %, about 99 wt % to about 99.9 wt %, about 99.1 wt % to about 99.9 wt %, about 99.2 wt % to about 99.9 wt %, about 99.3 wt % to about 99.9 wt %, about 99.4 wt % to about 99.9 wt %, about 99.5 wt % to about 99.9 wt %, about 99.6 wt % to about 99.9 wt %, about 99.7 wt % to about 99.9 wt %, about 95 wt % to about 99.7 wt %, about 96 wt % to about 99.7 wt %, about 97 wt % to about 99.7 wt %, about 98 wt % to about 99.7 wt %, about 99 wt % to about 99.7 wt %, about 95 wt % to about 99.5 wt %, about 96 wt % to about 99.5 wt %, about 97 wt % to about 99.5 wt %, about 98 wt % to about 99.5 wt %, or about 99 wt % to about 99.5 wt % of the total phosphate material contained in the phosphorous ore. In one specific example, the purified phosphate material can be about 98 wt % to about 99.9 wt % of the total phosphate material contained in the phosphorous ore.

In some examples, a tail material or gangue can be removed from the aqueous mixture or slurry, such as by froth flotation and/or submerged or flocculated. The tail material can include acid insoluble materials, gangue materials, and/or other impurities formerly contained in the phosphorous or phosphate containing ores, rocks, minerals, or other materials. The tail materials in the aqueous mixture can be collected, removed, or otherwise separated from the purified phosphate material. The tail material can generally be less than 99 wt % of the total acid insolubles contained in the phosphorous ore. For example, the tail material can be less than 97 wt %, less than 95 wt %, less than 90 wt %, less than 85 wt %, less than 80 wt %, less than 75 wt %, less than 70 wt %, less than 65 wt %, less than 60 wt %, less than 65 wt %, less than 50 wt % to about 40 wt %, about 30 wt %, about 20 wt %, about 10 wt %, about 5 wt %, or less, based on the total acid insolubles contained in the phosphorous ore. In some examples, the acid insolubles can be about 10 wt % to less than 97 wt %, about 25 wt % to less than 95 wt %, about 40 wt % to less than 95 wt %, about 50 wt % to less than 95 wt %, about 60 wt % to less than 95 wt %, about 70 wt % to less than 95 wt %, about 80 wt % to less than 95 wt %, about 90 wt % to less than 95 wt %, about 50 wt % to about 90 wt %, about 60 wt % to about 90 wt %, about 70 wt % to about 90 wt %, or about 80 wt % to about 90 wt %, based on the total acid insolubles contained in the phosphorous ore. In one specific example, a tail material collected from the aqueous mixture can include acid insolubles of about 70 wt % to about 90 wt % of the total acid insolubles contained in the phosphorous ore.

In one or more examples, the saccharide-based monoesters, e.g., sorbitan monoesters, which can be included, added, mixed, or otherwise combined with the tall oils to produce or otherwise form the aqueous mixture and/or the tall oil saccharide-based monoester composition or collector, e.g., tall oil-sorbitan ester composition or collector, can include one or more compounds and/or esters having the chemical formula (A) or (B). The R² in the chemical formulas (A) and (B) can be substituted or unsubstituted linear, branched, cyclic, heterocyclic, aromatic hydrocarbyl group, such as alkyl, alkenyl, alkynyl, aryl, alkoxyl, carboxylic acids, amino, saturated and/or unsaturated fatty acid groups, sugar groups, or isomers thereof. In some examples, the R² can be a hydrocarbyl group with 5, 6, 7, 8, 9, 10, 11, 12, 13, 14, 15, 16, 17, 18, 19, 20, 21, 22, 25, 30, or more carbon atoms. For example, the R² can be a C8 to C30 chain, a C10 to C24 chain, a C12 to C20 chain, a C14 to C20 chain, a C14 to C19 chain, a C14 to C18 chain, a C14 to C17 chain, a C14 to C16 chain, a C14 to C15 chain, a C15 to C20 chain, a C15 to C19 chain, a C15 to C18 chain, a C15 to C17 chain, or a C15 to C16 chain.

In some of the saccharide-based monoesters or sorbitan monoesters, the R² of the chemical formula (A) or (B) can have all saturated bonds, therefore no unsaturated bonds, such as saturated fatty acid groups. In other saccharide-based monoesters or sorbitan monoesters, the R² can have one or more unsaturated bonds, such as unsaturated fatty acid groups. The R², therefore, can have 0, 1, 2, 3, 4, 5, 6, 7, 8, 9, 10, 11, 12, 15, 20, or more unsaturated bonds. In some examples, the R² can have less than 10 unsaturated bonds, less than 8 unsaturated bonds, less than 6 unsaturated bonds, or less than 5 unsaturated bonds, such as, for example, 1, 2, 3, or 4 unsaturated bonds. In some examples, the R² can be a C8 to C30 chain having one or more unsaturated bonds. For example, the R² can be a C15 to C18 chain having 1 to 4 unsaturated bonds. In other examples, the R² can be a C15 to C17 chain having 1 to 3 unsaturated bonds.

The sorbitan monoester can be or include one ester or a mixture of esters. Illustrative sorbitan monoesters can include, but are not limited to, sorbitan monooleate, sorbitan monolinoleate, sorbitan monolinolenate, sorbitan monopalmitate, sorbitan monostearate, sorbitan monoarachidate, sorbitan monoabietate, sorbitan monopimarate, sorbitan monopalustrate, isomers thereof, or any mixture thereof. In one specific example, the sorbitan monoester can be or include sorbitan monooleate, sorbitan monolinoleate, sorbitan monolinolenate, sorbitan monopalmitate, isomers thereof, or any mixture thereof. In another specific example, the sorbitan monoester can be sorbitan monooleate.

The sorbitan monoester can be or include about 100 wt % of sorbitan monooleate, such as completely or substantially being or including sorbitan monooleate. In other examples, the amount of the sorbitan monooleate in the sorbitan monoester can be less than 100 wt % of sorbitan monooleate, such as, less than 99.9 wt %, less than 99.7 wt %, less than 99.5 wt %, less than 99 wt %, less than 98.5 wt %, less than 98 wt %, less than 97.5 wt %, less than 97 wt %, less than 96.5 wt %, less than 96 wt %, less than 95.5 wt %, less than 95 wt %, less than 94 wt %, less than 93 wt %, less than 92 wt %, less than 91 wt %, less than 90 wt %, less than 85 wt %, less than 80 wt %, less than 75 wt %, less than 70 wt %, less than 65 wt %, less than 60 wt %, less than 55 wt %, less than 50 wt % to about 45 wt %, about 40 wt %, about 35 wt %, or less. In some examples, the amount of the sorbitan monooleate in the sorbitan monoester can be about 20 wt % to about 99.9 wt %, about 30 wt % to about 99.5 wt %, about 40 wt % to about 99 wt %, about 40 wt % to about 95 wt %, about 50 wt % to about 95 wt %, about 60 wt % to about 95 wt %, or about 60 wt % to about 99 wt %.

In other examples, the amount of the sorbitan monooleate, sorbitan monolinoleate, sorbitan monolinolenate, sorbitan monopalmitate, or any mixture thereof in the sorbitan monoester can be 100 wt % or less than 100 wt %, such as, less than 99.9 wt %, less than 99.7 wt %, less than 99.5 wt %, less than 99 wt %, less than 98.5 wt %, less than 98 wt %, less than 97.5 wt %, less than 97 wt %, less than 96.5 wt %, less than 96 wt %, less than 95.5 wt %, less than 95 wt %, less than 94 wt %, less than 93 wt %, less than 92 wt %, less than 91 wt %, less than 90 wt %, less than 85 wt %, less than 80 wt %, less than 75 wt %, less than 70 wt %, less than 65 wt %, less than 60 wt %, less than 55 wt %, less than 50 wt % to about 45 wt %, about 40 wt %, about 35 wt %, or less. In some examples, the amount of the sorbitan monooleate, sorbitan monolinoleate, sorbitan monolinolenate, sorbitan monopalmitate, or any mixture thereof in the sorbitan monoester can be about 20 wt % to about 99.9 wt %, about 30 wt % to about 99.5 wt %, about 40 wt % to about 99 wt %, about 40 wt % to about 95 wt %, about 50 wt % to about 95 wt %, about 60 wt % to about 95 wt %, or about 60 wt % to about 99 wt %.

In another example, the amount of sorbitan monolinoleate, sorbitan monolinolenate, sorbitan monopalmitate, or any mixture thereof in the sorbitan monoester can be about 1 wt %, about 2 wt %, about 3 wt %, about 4 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or more. In some examples, the amount of sorbitan monolinoleate, sorbitan monolinolenate, sorbitan monopalmitate, or any mixture thereof in the sorbitan monoester can be about 1 wt % to about 80 wt %, about 1 wt % to about 60 wt %, about 1 wt % to about 50 wt %, about 1 wt % to about 40 wt %, about 10 wt % to about 80 wt %, about 10 wt % to about 60 wt %, about 10 wt % to about 50 wt %, or about 10 wt % to about 40 wt %.

In some examples, the sorbitan monoester can include about 40 wt % to about 99 wt % of sorbitan monooleate and about 1 wt % to about 60 wt % of sorbitan monolinoleate, sorbitan monolinolenate, sorbitan monopalmitate, or any mixture thereof. In other examples, the sorbitan monoester can include about 50 wt % to about 99 wt % of sorbitan monooleate and about 20 wt % to about 50 wt % of sorbitan monolinoleate, sorbitan monolinolenate, sorbitan monopalmitate, or any mixture thereof. In other examples, the sorbitan monoester can include about 60 wt % to about 99 wt % of sorbitan monooleate and about 5 wt % to about 40 wt % of sorbitan monolinoleate, sorbitan monolinolenate, sorbitan monopalmitate, or any mixture thereof.

In one or more examples, the tall oils which can be included, added, mixed, or otherwise combined with the saccharide-based monoesters, e.g., sorbitan monoesters, to produce or otherwise form the aqueous mixture and/or the tall oil saccharide-based monoester composition or collector, e.g., tall oil-sorbitan ester composition or collector, can include one or more crude tall oils (CTO), one or more distilled tall oils (DTO), one or more tall oil pitches, one or more tall oil fatty acids (TOFA), one or more tall oil rosin acids, fatty acids, rosin acids, or any mixture thereof. In one example, CTO can be made or produced as an acidified byproduct in the kraft or sulfate processing of wood. Crude tall oil, prior to refining, can include a mixture of rosin acids, fatty acids, sterols, high-molecular weight alcohols, and other alkyl chain materials. The components of CTO depend on a variety of factors, such as the particular coniferous species of the wood being processed (wood type), the geographical location of the wood source, the age of the wood, the particular season that the wood is harvested, and others. Thus, depending, at least in part, on the particular source, CTO can contain about 20 wt % to about 75 wt % of fatty acids, e.g., about 30 wt % to about 60 wt % of fatty acids, about 20 wt % to about 65 wt % of rosin acids, e.g., about 30 wt % to about 60 wt % of rosin acids, and the balance being the neutral and non-saponifiable components. In some examples, the CTO can include at least 8 wt % or about 10 wt % of neutral materials or non-saponifiable components.

Distillation of CTO can be used to recover a mixture of fatty acids having about 16 carbon atoms to about 20 carbon atoms. In some examples, these fatty acids can be included with the sorbitan monoesters to produce or otherwise form the aqueous mixture and/or the tall oil-sorbitan ester composition or collector. Fatty acids found in tall oils can include, but are not limited to, oleic acid, linoleic acid, stearic acid, and palmitic acid. Rosin acids found in tall oils, include, but are not limited to, abietic acid, dehydroabietic acid, isopimaric acid, and pimaric acid.

The distilled tall oil fraction can have a fatty acids and esters of fatty acids concentration of about 55 wt %, about 60 wt %, or about 65 wt % to about 85 wt %, about 90 wt %, or about 95 wt %. The distilled tall oil fraction can have a rosin acids or rosins concentration of about 5 wt %, about 10 wt %, or about 15 wt % to about 30 wt %, about 35 wt %, or about 40 wt %. The distilled tall oil fraction can have a neutrals concentration of about 0.1 wt %, about 1 wt %, or about 1.5 wt % to about 2 wt %, about 3.5 wt %, or about 5 wt %. The distilled tall oil fraction can have an acid value of about 20, about 25, or about 30 to about 40, about 45, or about 50. The distilled tall oil fraction can have a viscosity (centipoise at 85° C.) of about 10 cP, about 20 cP, about 30 cP, or about 40 cP to about 100 cP, about 120 cP, about 135 cP, or about 150 cP. The distilled tall oil can have a density of about 840 g/L, about 860 g/L, or about 880 g/L to about 900 g/L, about 920 g/L, or about 935 g/L. The distilled tall oil fraction can have a saponification number of about 180, about 185, or about 190 to about 200, about 205, or about 210. The distilled tall oil fraction can have an iodine value of about 115, about 117, or about 120 to about 130, about 135, or about 140.

The rosin acids derived from CTO are also an intermediate fraction that can be produced from the distillation of CTO. The tall oil rosin can have a concentration of rosin acids of about 80 wt %, about 85 wt %, or about 90 wt % to about 93 wt %, about 95 wt %, or about 99 wt %. The tall oil rosin can have a concentration of abietic acid of about 35 wt %, about 40 wt %, or about 43 wt % to about 50 wt %, about 55 wt %, or about 60 wt %. The tall oil rosin can have a concentration of dehydroabietic acid of about 10 wt %, about 13 wt %, or about 15 wt % to about 20 wt %, about 23 wt %, or about 25 wt %. The tall oil rosin can have a concentration of isopimaric acid of about 10 wt % or less, about 8 wt % or less, about 5 wt % or less, or about 3 wt % or less. The tall oil rosin can have a concentration of pimaric acid of about 10 wt % or less, about 8 wt % or less, about 5 wt % or less, or about 3 wt % or less. The tall oil rosin can have a fatty acids concentration of about 0.5 wt %, about 1 wt %, or about 2 wt % to about 3 wt %, about 5 wt %, or about 10 wt %. The tall oil rosin can have a concentration of neutral materials of about 0.5 wt %, about 1 wt %, or about 2 wt % to about 3 wt %, about 5 wt %, or about 10 wt %. The tall oil rosin can have a density of about 960 g/L, about 970 g/L, or about 980 g/L to about 1,000 g/L, about 1,010 g/L, or about 1,020 g/L. The tall oil rosin can have an acid value of about 150, about 160, or about 165 to about 170, about 175, or about 180.

Representative tall oil products can include, but are not limited to, saturated and unsaturated fatty acids in the C₁₆-C₁₈ range, as well as minor amounts of rosin acids, and can include XTOL® 100, XTOL® 300, and XTOL® 304, XTOL® 520, and LYTOR® 100, all of which are commercially available from Georgia-Pacific Chemicals LLC, Atlanta, Ga. XTOL® 100 includes about 1.6 wt % of palmitic acid, about 2.5 wt % of stearic acid, about 37.9 wt % of oleic acid, about 26.3 wt % of linoleic acid, about 0.3 wt % of linolenic acid, about 2.9 wt % of linoleic isomers, about 0.2 wt % of arachidic acid, about 3.6 wt % eicosatrienoic acid, about 1.4 wt % of pimaric acid, <0.16 wt % of sandarocopimaric, <0.16 wt % of isopimaric acid, <0.16 wt % of dehydroabietic acid, about 0.2 wt % of abietic acid, with the balance being neutrals and high molecular weight species. LYTOR® 100 includes <0.16 wt % of palmitic acid, <0.16 wt % of stearic acid, about 0.2 wt % of oleic acid, about 0.2 wt % of arachidic acid, about 0.2 wt % eicosatrienoic acid, about 2.2 wt % of pimaric acid, about 0.6 wt % of sandarocopimaric, about 8.5 wt % of palustric acid, about 1.6 wt % of levopimaric acid, about 2.8 wt % of isopimaric acid, about 15.3 wt % of dehydroabietic acid, about 51.4 wt % of abietic acid, about 2.4 wt % of neoabietic acid, with the balance being neutrals and high molecular weight species. XTOL® 520 DTO includes about 0.2 wt % of palmitic acid, about 3.3 wt % of stearic acid, about 37.9 wt % of oleic acid, about 26.3 wt % of linoleic acid, about 0.3 wt % of linolenic acid, about 2.9 wt % of linoleic isomers, about 0.2 wt % of arachidic acid, about 3.6 wt % eicosatrienoic acid, about 1.4 wt % of pimaric acid, <0.16 wt % wt % of sandarocopimaric acid, <0.16 wt % of isopimaric acid, <0.16 wt % of dehydroabietic acid, about 0.2 wt % of abietic acid, with the balance being neutrals and high molecular weight species. Such tall oil products can be used in the reaction with the polyamine or a mixture of polyamines. Other fatty acids and mixtures of fatty acids, including oxidized and/or dimerized tall oil, such those discussed below can also be employed.

In one or more examples, the aqueous mixture, the tall oil saccharide-based monoester composition or collector, and/or the tall oil-sorbitan ester composition or collector can include a fatty acid, a mixture of fatty acids, a fatty acid ester, a mixture of fatty acid esters, or a mixture of one or more fatty acids and one or more fatty acid esters. The fatty acids can be combined with the tall oils and the saccharide-based monoesters, e.g., sorbitan monoesters, to produce or otherwise form the aqueous mixture and/or the tall oil saccharide-based monoester composition or collector, e.g., tall oil-sorbitan ester composition or collector. In other examples, the fatty acids can be used instead of the tall oils, therefore, the fatty acids can be combined with the saccharide-based monoesters, e.g., sorbitan monoesters, to produce or otherwise form the aqueous mixture and/or the tall oil saccharide-based monoester composition or collector, e.g., tall oil-sorbitan ester composition or collector. Representative fatty acids that can be included in the aqueous solution, the tall oil saccharide-based monoester composition or collector, and/or the tall oil-sorbitan ester composition or collector can include oleic acid, lauric acid, linoleic acid, linolenic acid, palmitic acid, stearic acid, isostearic acid, ricinoleic acid, myristic acid, arachidic acid, behenic acid and mixtures thereof.

The aqueous solution, the tall oil saccharide-based monoester composition or collector, and/or the tall oil-sorbitan ester composition or collector can include fatty acids from various plant and/or vegetable oil sources. Illustrative plant or vegetable oils that can be used as the fatty acids can include, but are not limited to, safflower oil, grapeseed oil, sunflower oil, walnut oil, soybean oil, cottonseed oil, coconut oil, corn oil, olive oil, palm oil, palm olein, peanut oil, rapeseed oil, canola oil, sesame oil, hazelnut oil, almond oil, beech nut oil, cashew oil, macadamia oil, mongongo nut oil, pecan oil, pine nut oil, pistachio oil, grapefruit seed oil, lemon oil, orange oil, watermelon seed oil, bitter gourd oil, buffalo gourd oil, butternut squash seed oil, egusi seed oil, pumpkin seed oil, borage seed oil, blackcurrant seed oil, evening primrose oil, acai oil, black seed oil, flaxseed oil, carob pod oil, amaranth oil, apricot oil, apple seed oil, argan oil, avocado oil, babassu oil, ben oil, borneo tallow nut oil, cape chestnut, algaroba oil, cocoa butter, cocklebur oil, poppyseed oil, cohune oil, coriander seed oil, date seed oil, dika oil, false flax oil, hemp oil, kapok seed oil, kenaf seed oil, lallemantia oil, mafura oil, manila oil, meadowfoam seed oil, mustard oil, okra seed oil, papaya seed oil, perilla seed oil, persimmon seed oil, pequi oil, pili nut oil, pomegranate seed oil, prune kernel oil, quinoa oil, ramtil oil, rice bran oil, royle oil, shea nut oil, sacha inchi oil, sapote oil, seje oil, taramira oil, tea seed oil, thistle oil, tigernut oil, tobacco seed oil, tomato seed oil, wheat germ oil, castor oil, colza oil, flax oil, radish oil, salicornia oil, tung oil, honge oil, jatropha oil, jojoba oil, nahor oil, paradise oil, petroleum nut oil, dammar oil, linseed oil, stillingia oil, vernonia oil, amur cork tree fruit oil, artichoke oil, balanos oil, bladderpod oil, brucea javanica oil, burdock oil, candlenut oil, carrot seed oil, chaulmoogra oil, crambe oil, croton oil, cuphea oil, honesty oil, mango oil, neem oil, oojon oil, rose hip seed oil, rubber seed oil, sea buckthorn oil, sea rocket seed oil, snowball seed oil, tall oil, tamanu oil, tonka bean oil, ucuhuba seed oil, or any mixture thereof. Illustrative animal fats or oils that can be used as the fatty acids can include, but are not limited to, fatty acids from animal sources, such as cows, pigs, lambs, chickens, turkeys, geese, and other animals, as well as dairy products such as milk, butter, or cheese. Illustrative fatty acids from animal sources can include palmitic acid, stearic acid, myristic acid, oleic acid, palmitoleic acid, linoleic acid, or any mixture thereof.

If the fatty acid in the tall oil includes two or more fatty acids, each fatty acid can be present in the same concentration or different concentrations with respect to one another. For example, a first fatty acid can be present in a weight ratio of about 99:1, about 90:10, about 80:20, about 70:30, about 60:40, about 50:50, about 40:60, about 30:70, about 20:80, about 10:90, or about 1:99 with respect to another or “second” fatty acid contained therein. Similarly, if three or more fatty acids are mixed, the three or more fatty acids can be present in any ratio.

The aqueous mixtures which can include water, one or more ores, e.g., phosphorous ores, one or more tall oils, and one or more sorbitan monoesters, including aqueous suspensions, dispersions, slurries, solutions, or mixtures, can be conditioned for a given time period during and between steps of combining components. Conditioning the aqueous mixture upon the addition of water, the ore, the tall oil, and/or the saccharide-based monoesters, e.g., sorbitan monoesters, can facilitate contact between the components. Conditioning can include, but is not limited to, agitating the aqueous mixture for a given time period prior to subjecting the aqueous mixture to separation or collection techniques. For example, the aqueous mixtures can be stirred, blended, mixed, air or gas bubbled, or otherwise agitated for a time of about 30 seconds, about 1 minute, about 2 minutes, about 3 minutes, about 4 minutes, about 5 minutes, about 6 minutes, about 7 minutes, about 8 minutes, about 9 minutes, about 10 minutes, about 12 minutes, about 15 minutes, about 20 minutes, about 30 minutes, about 1 hour, or about 24 hours. Conditioning the aqueous mixture can also include heating (or cooling) the mixture to a temperature of about 15° C., about 20° C., about 25° C., about 30° C., about 35° C., about 60° C., about 80° C., or about 95° C.

Conditioning the aqueous mixture can also include adjusting the pH values of any of portions of and including the aqueous mixtures. The pH value of the aqueous mixture that includes water, the ore, e.g., phosphorous ore, the tall oil, and/or the saccharide-based monoesters, e.g., sorbitan monoesters, can be maintained or adjusted so to be greater than 7, such as about 7.5, about 8, about 8.5, about 9, about 9.5, about 10, about 10.5, about 11, about 11.5, about 12, about 12.5, or about 13. In one or more examples, the pH value of an aqueous slurry containing the phosphorous ore can be or can be adjusted to about 8.5 to about 10.5, about 9 to about 10, about 9.2 to about 9.8, or about 9.5. In other examples, the pH value of the aqueous mixture containing the ore, e.g., phosphorous ore, the tall oil, and the saccharide-based monoesters, e.g., sorbitan monoesters, can be or can be adjusted to about 8.5 to about 10.5, about 9 to about 10, about 9.2 to about 9.8, or about 9.5. Any one or combination of acid and/or base compounds can be combined with the mixtures to adjust the pH thereof.

Illustrative acid compounds that can be used to maintain or adjust the pH value of any of the aqueous mixtures can include, but are not limited to, one or more mineral acids, one or more organic acids, one or more acid salts, or any mixture thereof. Illustrative mineral acids can include, but are not limited to, hydrochloric acid, nitric acid, phosphoric acid, sulfuric acid, or any mixture thereof. Illustrative organic acids can include, but are not limited to, acetic acid, formic acid, citric acid, oxalic acid, uric acid, lactic acid, or any mixture thereof. Illustrative acid salts can include, but are not limited to, ammonium sulfate, sodium bisulfate, sodium metabisulfite, or any mixture thereof.

Illustrative base compounds that can be used to maintain or adjust the pH value of any of the aqueous mixtures can include, but are not limited to, hydroxides, carbonates, ammonia, amines, or any mixture thereof. Illustrative hydroxides can include, but are not limited to, sodium hydroxide, potassium hydroxide, ammonium hydroxide, e.g., aqueous ammonia, lithium hydroxide, and cesium hydroxide. Illustrative carbonates can include, but are not limited to, sodium carbonate, sodium bicarbonate, potassium carbonate, and ammonium carbonate. Illustrative amines can include, but are not limited to, trimethylamine, triethylamine, triethanolamine, diisopropylethylamine (Hunig's base), pyridine, 4-dimethylaminopyridine (DMAP), and 1,4-diazabicyclo[2.2.2]octane (DABCO).

In one or more examples, the collector-treated and pH-adjusted aqueous mixture can be aerated in a conventional flotation machine or bank of rougher cells to float impurities and gangue materials for separating and purifying ores. Any conventional flotation unit can be employed. The tall oil saccharide-based monoester collector, e.g., tall oil-sorbitan ester collector, can be used to separate a wide variety of contaminants from a liquid, e.g., water. For example, the tall oil saccharide-based monoester collector can be used to separate siliceous contaminants such as sand, clay, and/or ash from aqueous liquid suspensions, dispersions, slurries, solutions, or other mixtures containing one or more of these siliceous contaminants. Aqueous mixtures can therefore be treated with the tall oil saccharide-based monoester collector allowing for the effective separation of at least a portion of the contaminants, in a contaminant-rich fraction, to provide a purified liquid. The contaminant-rich fraction contains a higher percentage of solid contaminants than originally present in the aqueous mixture. Conversely, the purified liquid has a lower percentage of solid contaminants than originally present in the aqueous mixture.

The treatment can involve adding an effective amount of the tall oil saccharide-based monoester composition or collector to interact with and float one or more solid contaminants. An effective amount can be readily determined depending, at least in part, on a number of variables, e.g., the type and concentration of contaminant. In other examples, the treatment can involve contacting the aqueous mixture or slurry continuously with a fixed bed of the tall oil saccharide-based monoester composition or collector, in solid form.

During or after the treatment of the aqueous mixture or slurry with the tall oil saccharide-based monoester composition or collector, the coagulated solid contaminant (which can now be, for example, in the form of larger, agglomerated particles or flocs) can be removed. Removal can be affected by flotation (with or without the use of rising air bubbles), such as in a froth flotation, or skimming. Filtration or straining can also be an effective means for removing the agglomerated flocs of solid particulates on the surface of the aqueous mixture or slurry.

Considering froth flotation in more detail, froth flotation is a separation process based on differences in the tendency of various materials to associate with rising air bubbles. The collector and optionally a dispersant, a depressant, and/or other additives can be combined with water and an ore that includes one or more contaminants to produce an aqueous slurry or other mixture. A gas, e.g., air, can be flowed, forced, or otherwise passed through the mixture. Some materials (e.g., value minerals) will, relative to others (e.g., contaminants), exhibit preferential affinity for air bubbles, causing them to rise to the surface of the aqueous slurry, where they can be collected in a froth concentrate. A degree of separation is thereby provided. In “reverse” froth flotation, it is the contaminant that can preferentially float and concentrated at the surface, with the ore and/or other value material concentrated in the bottoms. The relatively hydrophobic fraction of the material can have a selective affinity for the rising bubbles and can float to the surface, where it can be skimmed off and recovered. The relatively hydrophilic fraction of the material can flow or otherwise move toward the bottom of the aqueous mixture and can be recovered as a bottoms fraction. Froth flotation is a separation process well known to those skilled in the art.

As used herein, the term “purifying” broadly refers to any process for beneficiation, upgrading, and/or recovering, a value material as described herein, such as phosphates or other phosphorous containing materials. In some examples, the aqueous mixture can include the clay-containing aqueous suspensions or brines, which accompany ore refinement processes, including those described above. The production of purified phosphate from mined calcium phosphate rock, for example, generally relies on multiple separations of solid particulates from aqueous media, whereby such separations can be improved using the tall oil saccharide-based monoester composition or collector. In the overall process, calcium phosphate can be mined from deposits and the phosphate rock can be initially recovered in a matrix containing sand and clay impurities. The matrix can be mixed with water to form a slurry, which after mechanical agitation, can be screened to retain phosphate pebbles and to allow fine clay particles to pass through as a clay slurry effluent with large amounts of water.

These clay-containing effluents can have high flow rates and typically carry less than 10 wt % solids and more often contain only about 1 wt % to about 5 wt % solids. The dewatering, e.g., by settling or filtration, of this waste clay, which allows for recycle of the water, poses a significant challenge for reclamation. The time required to dewater the clay, however, can be decreased through treatment of the clay slurry effluent, obtained in the production of phosphate, with the tall oil saccharide-based monoester collector. Reduction in the clay settling time allows for efficient re-use of the purified water, obtained from clay dewatering, in the phosphate production operation. In one example of the purification method, where the aqueous mixture or slurry is a clay-containing effluent slurry from a phosphate production facility, the purified liquid can contain less than 1 wt % solids after a settling or dewatering time of less than 1 month.

In addition to the phosphate pebbles that can be retained by screening and the clay slurry effluent described above, a mixture of sand and finer particles of phosphate can also obtained in the initial processing of the mined phosphate matrix. The sand and phosphate in this stream can be separated by froth flotation which, as described above, can be improved using the tall oil saccharide-based monoester collector as a depressant for the sand.

### EXAMPLES

In order to provide a better understanding of the foregoing discussion, the following non-limiting examples are offered. Although the examples can be directed to specific examples, they are not to be viewed as limiting the invention in any specific respect.

The synergetic effects for selective phosphate flotation were due to the combination of the tall oils and the sorbitan monoester modifiers as highlighted by the results of Examples 1A-11C, summarized below in Tables 1 and 2. The collector-modifier mixture contained varying amount of tall oils, e.g., TOFA or CTO, and sorbitan monoesters within each exemplary phosphate flotation.

Flotation experiments were performed on various combinations and concentrations of tall oils and sorbitan monooleate having the chemical formula (B) relative to a constant concentration of the phosphate ore. Comparison experiments were performed with similar concentrations and conditions, but with polysorbate 80 instead of sorbitan monooleate. The flotation experiments for Examples 1A-6C were performed on a phosphate ore source supplied by the CF Industries Holding, Inc., Deerfield, Ill. The flotation experiments for Examples 7A-11C were performed on a phosphate ore source supplied by The Mosaic Company, Plymouth, Minn.

The collector modifier used in Examples 1A-1C, 2A-2C, 7A-7C, and 8A-8C was polysorbate 80, chemically known as polyoxyethylene (20) sorbitan monooleate, and was commercially available as TWEEN® 80 from Sigma-Aldrich Company, LLC, St. Louis, Mo. The collector modifier used in Examples 3A-3C, 4A-4C, 9A-9C, and 10A-10C was a nonionic surfactant that contains sorbitan monoesters, such as sorbitan monooleate, and was commercially available as SPAN® 80 from Sigma-Aldrich Company, LLC, St. Louis, Mo. The tall oils used in Experiments 1A-11C were CTO or TOFA, and was commercially available as CTO or XTOL® 100 tall oil from Georgia-Pacific Chemicals LLC, Atlanta, Ga.

### Examples 1A-1C

About 500 grams of dried phosphate ore (CF INDUSTRIES® phosphate ore), about 2.5 mL of 1 N NaOH solution (to adjust the pH of the mixture to about 9.5), about 0.5 g (Ex. 1A), about 1 g (Ex. 1B), about 1.5 g (Ex. 1C) of a collector/extender oil blend (about 98 wt % of tall oil and about 2 wt % of polysorbate 80), and water were added in a 2 L capacity stainless steel beaker. Water was added in an amount to provide a solids content of about 70 wt % of the mixture in the stainless steel beaker.

### Examples 2A-2C

About 500 grams of dried phosphate ore (CF INDUSTRIES® phosphate ore), about 2.5 mL of 1 N NaOH solution (to adjust the pH of the mixture to about 9.5), about 0.5 g (Ex. 2A), about 1 g (Ex. 2B), about 1.5 g (Ex. 2C) of a collector/extender oil blend (about 91 wt % of tall oil and about 9 wt % of polysorbate 80), and water were added in a 2 L capacity stainless steel beaker. Water was added in an amount to provide a solids content of about 70 wt % of the mixture in the stainless steel beaker.

### Examples 3A-3C

About 500 grams of dried phosphate ore (CF INDUSTRIES® phosphate ore), about 2.5 mL of 1 N NaOH solution (to adjust the pH of the mixture to about 9.5), about 0.5 g (Ex. 3A), about 1 g (Ex. 3B), about 1.5 g (Ex. 3C) of a collector/extender oil blend (about 98 wt % of tall oil and about 2 wt % of sorbitan monooleate), and water were added in a 2 L capacity stainless steel beaker. Water was added in an amount to provide a solids content of about 70 wt % of the mixture in the stainless steel beaker.

### Examples 4A-4C

About 500 grams of dried phosphate ore (CF INDUSTRIES® phosphate ore), about 2.5 mL of 1 N NaOH solution (to adjust the pH of the mixture to about 9.5), about 0.5 g (Ex. 4A), about 1 g (Ex. 4B), about 1.5 g (Ex. 4C) of a collector/extender oil blend (about 91 wt % of tall oil and about 9 wt % of sorbitan monooleate), and water were added in a 2 L capacity stainless steel beaker. Water was added in an amount to provide a solids content of about 70 wt % of the mixture in the stainless steel beaker.

### Examples 5A-5C

About 500 grams of dried phosphate ore (CF INDUSTRIES® phosphate ore), about 2.5 mL of 1 N NaOH solution (to adjust the pH of the mixture to about 9.5), about 0.5 g (Ex. 5A), about 1 g (Ex. 5B), about 1.5 g (Ex. 5C) of sorbitan monooleate, and water were added in a 2 L capacity stainless steel beaker. Water was added in an amount to provide a solids content of about 70 wt % of the mixture in the stainless steel beaker.

### Examples 6A-6C

About 500 grams of dried phosphate ore (CF INDUSTRIES® phosphate ore), about 2.5 mL of 1 N NaOH solution (to adjust the pH of the mixture to about 9.5), about 0.5 g (Ex. 6A), about 1 g (Ex. 6B), about 1.5 g (Ex. 6C) of crude tall oils, and water were added in a 2 L capacity stainless steel beaker. Water was added in an amount to provide a solids content of about 70 wt % of the mixture in the stainless steel beaker.

### Examples 7A-7C

About 500 grams of dried phosphate ore (MOSAIC phosphate ore), about 2.5 mL of 1 N NaOH solution (to adjust the pH of the mixture to about 9.5), about 0.5 g (Ex. 7A), about 1 g (Ex. 7B), about 1.5 g (Ex. 7C) of a collector/extender oil blend (about 98 wt % of tall oil and about 2 wt % of polysorbate 80), and water were added in a 2 L capacity stainless steel beaker. Water was added in an amount to provide a solids content of about 70 wt % of the mixture in the stainless steel beaker.

### Examples 8A-8C

About 500 grams of dried phosphate ore (MOSAIC® phosphate ore), about 2.5 mL of 1 N NaOH solution (to adjust the pH of the mixture to about 9.5), about 0.5 g (Ex. 8A), about 1 g (Ex. 8B), about 1.5 g (Ex. 8C) of a collector/extender oil blend (about 91 wt % of tall oil and about 9 wt % of polysorbate 80), and water were added in a 2 L capacity stainless steel beaker. Water was added in an amount to provide a solids content of about 70 wt % of the mixture in the stainless steel beaker.

### Examples 9A-9C

About 500 grams of dried phosphate ore (MOSAIC phosphate ore), about 2.5 mL of 1 N NaOH solution (to adjust the pH of the mixture to about 9.5), about 0.5 g (Ex. 9A), about 1 g (Ex. 9B), about 1.5 g (Ex. 9C) of a collector/extender oil blend (about 98 wt % of tall oil and about 2 wt % of sorbitan monooleate), and water were added in a 2 L capacity stainless steel beaker. Water was added in an amount to provide a solids content of about 70 wt % of the mixture in the stainless steel beaker.

### Examples 10A-10C

About 500 grams of dried phosphate ore (MOSAIC® phosphate ore), about 2.5 mL of 1 N NaOH solution (to adjust the pH of the mixture to about 9.5), about 0.5 g (Ex. 10), about 1 g (Ex. 10B), about 1.5 g (Ex. 10C) of a collector/extender oil blend (about 91 wt % of tall oil and about 9 wt % of sorbitan monooleate), and water were added in a 2 L capacity stainless steel beaker. Water was added in an amount to provide a solids content of about 70 wt % of the mixture in the stainless steel beaker.

### Examples 11A-11C

About 500 grams of dried phosphate ore (MOSAIC® phosphate ore), about 2.5 mL of 1 N NaOH solution (to adjust the pH of the mixture to about 9.5), about 0.5 g (Ex. 11A), about 1 g (Ex. 11B), about 1.5 g (Ex. 11C) of crude tall oils, and water were added in a 2 L capacity stainless steel beaker. Water was added in an amount to provide a solids content of about 70 wt % of the mixture in the stainless steel beaker.

### Work-Up of Examples 1A-11C

A cruciform impeller was used to agitate the mixture at about 400 RPM for about 2.5 minutes to produce a slurry in the stainless steel beaker. The slurry was transferred to a 2 L DENVER® flotation cell. Water was added to the slurry to adjust the solids content to about 20%. The slurry was mixed with an impeller and NaOH solution (about 1 N) was added to the slurry to adjust the pH to about 9.5. Solids were slurried or otherwise floated using the DENVER® D12 flotation machine for about 2 minutes and stirred at a rate of about 1,500 rpm. A concentrate sample (floated, filtered material) and a tail sample tail (material left in cell) were separated from one another with shark skin filter paper (e.g., Ahlstrom Equivalent Shark Skin Filter Paper 9920-3850) and vacuum filtration. Both samples were dried in an oven at about 100° C. The dried concentrate sample and the dried tail sample were individually weighed and individually mixed to form homogeneous samples. The concentrate sample and the tail sample were individually analyzed by inductively coupled plasma (ICP) analysis for the weight percentage of bone phosphate of lime (BPL), phosphorous pentoxide (P₂O₅), and acid insolubles.

Found here was the surprising and unexpected result that the combination of tall oils and the very hydrophobic sorbitan monooleates showed a synergistic effect as a collector for phosphorous containing materials. That is, the combination of reagents performed better than did either the tall oil alone or the sorbitan monooleate alone for impurity flotation in phosphate ore beneficiation. The combination of tall oils and sorbitan monooleates provided greater yields of phosphates and greater phosphate selectivity. Polysorbate 80 was used as a comparative compound to sorbitan monooleate. Combinations of the tall oil and polysorbate 80 were investigated as collectors for phosphates, but lacked the yield and selectivity to phosphate as did the tall oil and sorbitan monooleate compositions.

Surprisingly, sorbitan monooleate performed better as a collector modifier in the rougher float of CF INDUSTRIES® phosphate ore (CF Industries Holding, Inc., Deerfield, Ill.) than did polysorbate 80, as summarized in Table 1. The combinations of tall oil and polysorbate 80 showed very little benefit at room temperature (about 25° C.). The use of sorbitan monooleate alone served as an effective collector. The collectors, however, which contained a mixture of tall oil and sorbitan monooleate provided improved phosphate beneficiation with greater phosphate yields and greater phosphate selectivity from the phosphate ore floats.

In Experiments 1A-1C, a 98:2 weight ratio of tall oil collector/polysorbate 80 mixture was used as the collector and recovery/AI rejections of 66.77%/96.87%, 95.29%/86.94%, and 97.94%/79.36% at 2, 4, and 6 lbs/ton, respectively. In Experiments 2A-2C, a 91:9 weight ratio of tall oil collector/polysorbate 80 mixture was used as the collector and recovery/AI rejections of 61.18%/96.12%, 93.37%/86.62%, and 97.68%/86.37% were achieved at 2, 4, and 6 lbs/ton, respectively. Increasing the concentration of polysorbate 80 (from Experiments 1A-1C to Experiments 2A-2C) provided negative results, both recovery and AI rejections dropped in value.

In Experiments 3A-3C, a 98:2 weight ratio of tall oil collector/sorbitan monooleate mixture was used as the collector and recovery/AI rejections of 75.16%/96.58%, 95.92%/85.23%, and 98.45%/79.36% at 2, 4, and 6 lbs/ton, respectively. In Experiments 4A-4C, a 91:9 weight ratio of tall oil collector/sorbitan monooleate mixture was used as the collector and recovery/AI rejections of 74.98%/96.42%, 96.82%/89.36%, and 99.65%/79.11% were achieved at 2, 4, and 6 lbs/ton, respectively. Increasing the concentration of sorbitan monooleate (from Experiments 3A-3C to Experiments 4A-4C) improved results significantly.

In Experiments 5A-5C, sorbitan monooleate alone was used as the collector and the recovery/acid insoluble (AI) rejections of 25.02%/98.18%, 77.33%/95.58%, and 85.75%/92.59% were achieved at 2, 4, and 6 lbs/ton, respectively. In Experiments 6A-6C, CTO alone was used as the collector and recovery/AI rejections of 78.98%/89.98%, 95.39%/84.04%, and 95.71%/79.36% were achieved at 2, 4, and 6 lbs/ton, respectively.

TABLE 1
Phosphate recovery from CF INDUSTRIES ® phosphate ore

| | | | Dosage | | | |
|---|---|---|---|---|---|---|
| Ex- | Fatty | | (lb/ton) | P₂O₅ | A.I. | Separation |
| am- | Acid | Modifier | [kg/ | Recov. | Reject. | Efficiency |
| ples | (wt %) | (wt %) | tonne] | (%) | (%) | (%) |
| 1A | tall oil | polysorbate | 2 [1] | 66.77% | 96.87% | 63.64% |
| | (98%) | 80 | | | | |
| | | (2%) | | | | |
| 1B | tall oil | polysorbate | 4 [2] | 95.29% | 86.94% | 82.23% |
| | (98%) | 80 | | | | |
| | | (2%) | | | | |
| 1C | tall oil | polysorbate | 6 [3] | 97.94% | 79.36% | 77.30% |
| | (98%) | 80 | | | | |
| | | (2%) | | | | |
| 2A | tall oil | polysorbate | 2 [1] | 61.18% | 96.12% | 57.30% |
| | (91%) | 80 | | | | |
| | | (9%) | | | | |
| 2B | tall oil | polysorbate | 4 [2] | 93.37% | 86.62% | 79.99% |
| | (91%) | 80 | | | | |
| | | (9%) | | | | |
| 2C | tall oil | polysorbate | 6 [3] | 97.68% | 86.37% | 84.05% |
| | (91%) | 80 | | | | |
| | | (9%) | | | | |
| 3A | tall oil | sorbitan | 2 [1] | 75.16% | 96.58% | 71.74% |
| | (98%) | monooleate | | | | |
| | | (2%) | | | | |
| 3B | tall oil | sorbitan | 4 [2] | 95.92% | 85.23% | 81.15% |
| | (98%) | monooleate | | | | |
| | | (2%) | | | | |
| 3C | tall oil | sorbitan | 6 [3] | 98.45% | 79.36% | 77.81% |
| | (98%) | monooleate | | | | |
| | | (2%) | | | | |
| 4A | tall oil | sorbitan | 2 [1] | 74.98% | 96.42% | 71.40% |
| | (91%) | monooleate | | | | |
| | | (9%) | | | | |
| 4B | tall oil | sorbitan | 4 [2] | 96.82% | 89.36% | 86.18% |
| | (91%) | monooleate | | | | |
| | | (9%) | | | | |
| 4C | tall oil | sorbitan | 6 [3] | 99.65% | 79.11% | 78.76% |
| | (91%) | monooleate | | | | |
| | | (9%) | | | | |
| 5A | — | sorbitan | 2 [1] | 25.02% | 98.18% | 23.20% |
| | | monooleate | | | | |
| | | (100%) | | | | |
| 5B | — | sorbitan | 4 [2] | 77.33% | 95.58% | 72.91% |
| | | monooleate | | | | |
| | | (100%) | | | | |
| 5C | — | sorbitan | 6 [3] | 85.75% | 92.59% | 78.34% |
| | | monooleate | | | | |
| | | (100%) | | | | |
| 6A | tall oil | — | 2 [1] | 78.98% | 89.98% | 68.96% |
| | (100%) | | | | | |
| 6B | tall oil | — | 4 [2] | 95.39% | 84.04% | 79.43% |
| | (100%) | | | | | |
| 6C | tall oil | — | 6 [3] | 95.71% | 79.36% | 75.07% |
| | (100%) | | | | | |

Similarly surprising, but the effect was even more pronounced, sorbitan monooleate performed better as a modifier in the rougher float of MOSAIC® phosphate ore (The Mosaic Company, Plymouth, Minn.) than did pure tall oil or a mixture of tall oil and polysorbate 80, as summarized in Table 2. The combinations of tall oil and polysorbate 80 showed very little benefit at room temperature (about 25° C.). Similar to the above described results with the CF INDUSTRIES® phosphate ore, the use of sorbitan monooleate alone served as an effective collector in the floats of MOSAIC® phosphate ore. Also, the collectors which contained a mixture of tall oil and sorbitan monooleate provided improved phosphate beneficiation with greater phosphate yields and greater phosphate selectivity from the phosphate ore floats.

In Experiments 7A-7C, a 98:2 weight ratio of tall oil collector/polysorbate 80 mixture was used as the collector and recovery/AI rejections of 86.68%/86.63%, 94.89%/63.83%, and 96.47%/71.21% at 2, 4, and 6 lbs/ton, respectively. In Experiments 8A-8C, a 91:9 weight ratio of tall oil collector/polysorbate 80 mixture was used as the collector and recovery/AI rejections of 86.87%/85.53%, 95.94%/76.84%, and 95.76%/69.68% were achieved at 2, 4, and 6 lbs/ton, respectively. Increasing the concentration of polysorbate 80 (from Experiments 7A-7C to Experiments 8A-8C) provided very little result changes in phosphate recovery but had slightly increased values in AI rejections. In Experiments 9A-9C, a 98:2 weight ratio of tall oil collector/sorbitan monooleate mixture was used as the collector and recovery/AI rejections of 90.17%/83.54%, 98.12%/61.93%, and 99.30%/80.76% at 2, 4, and 6 lbs/ton, respectively.

In Experiments 10A-10C, a 91:9 weight ratio of tall oil collector/sorbitan monooleate mixture was used as the collector and recovery/AI rejections of 96.29%/88.42%, 98.34%/54.97%, and 98.90%/72.80% were achieved at 2, 4, and 6 lbs/ton, respectively. Increasing the concentration of sorbitan monooleate (from Experiments 9A-9C to Experiments 10A-10C) provided very little result changes in phosphate recovery but had slightly decreased values in AI rejections.

In Experiments 11A-11C, CTO alone was used as the collector and recovery/AI rejections of 70.74%/95.03%, 99.47%/68.11%, and 98.26%/61.73% were achieved at 2, 4, and 6 lbs/ton, respectively.

TABLE 2
Phosphate recovery from MOSAIC ® phosphate ore

| | | | Dosage | | | |
|---|---|---|---|---|---|---|
| Ex- | Fatty | | (lb/ton) | P₂O₅ | A.I. | Separation |
| am- | Acid | Modifier | [kg/ | Recov. | Reject | Efficiency |
| ples | (wt %) | (wt %) | tonne] | (%) | (%) | (%) |
| 7A | tall oil | polysorbate | 2 [1] | 86.68% | 86.63% | 73.31% |
| | (98%) | 80 | | | | |
| | | (2%) | | | | |
| 7B | tall oil | polysorbate | 4 [2] | 94.89% | 63.83% | 58.72% |
| | (98%) | 80 | | | | |
| | | (2%) | | | | |
| 7C | tall oil | polysorbate | 6 [3] | 96.47% | 71.21% | 67.68% |
| | (98%) | 80 | | | | |
| | | (2%) | | | | |
| 8A | tall oil | polysorbate | 2 [1] | 86.87% | 85.53% | 72.40% |
| | (91%) | 80 | | | | |
| | | (9%) | | | | |
| 8B | tall oil | polysorbate | 4 [2] | 95.94% | 76.83% | 72.77% |
| | (91%) | 80 | | | | |
| | | (9%) | | | | |
| 8C | tall oil | polysorbate | 6 [3] | 95.76% | 69.68% | 65.44% |
| | (91%) | 80 | | | | |
| | | (9%) | | | | |
| 9A | tall oil | sorbitan | 2 [1] | 90.17% | 83.54% | 73.71% |
| | (98%) | monooleate | | | | |
| | | (2%) | | | | |
| 9B | tall oil | sorbitan | 4 [2] | 98.12% | 61.93% | 60.05% |
| | (98%) | monooleate | | | | |
| | | (2%) | | | | |
| 9C | tall oil | sorbitan | 6 [3] | 99.30% | 80.76% | 80.06% |
| | (98%) | monooleate | | | | |
| | | (2%) | | | | |
| 10A | tall oil | sorbitan | 2 [1] | 96.29% | 88.42% | 84.71% |
| | (91%) | monooleate | | | | |
| | | (9%) | | | | |
| 10B | tall oil | sorbitan | 4 [2] | 98.34% | 54.97% | 53.31% |
| | (91%) | monooleate | | | | |
| | | (9%) | | | | |
| 10C | tall oil | sorbitan | 6 [3] | 98.90% | 72.80% | 71.70% |
| | (91%) | monooleate | | | | |
| | | (9%) | | | | |
| 11A | tall oil | — | 2 [1] | 70.74% | 95.03% | 65.77% |
| | (100%) | | | | | |
| 11B | tall oil | — | 4 [2] | 99.47% | 68.11% | 67.58% |
| | (100%) | | | | | |
| 11C | tall oil | — | 6 [3] | 98.26% | 61.73% | 59.99% |
| | (100%) | | | | | |

Embodiments of the present disclosure further relate to any one or more of the following paragraphs:

1. A method for purifying a phosphorous containing material, comprising combining water, a phosphorous ore, a tall oil, and a saccharide-based monoester to produce an aqueous mixture, wherein the saccharide-based monoester comprises one or more esters having the chemical formula:

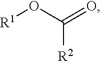

wherein: R¹ is a saccharide group having 1 to 14 hydroxyl groups, and R² is a C9 to C24 chain having 1 to 5 unsaturated bonds; and collecting a purified phosphate material from the aqueous mixture.

2. The method according to paragraph 1, wherein R¹ is a monosaccharide group having 1 to 8 hydroxyl groups.

3. The method according to paragraph 1 or 2, wherein R¹ is a monosaccharide group prepared from fructose, galactose, glucose, mannose, ribose, sorbose, xylose, or isomers thereof.

4. The method according to paragraph 1, wherein R¹ is a disaccharide group having 1 to 10 hydroxyl groups.

5. The method according to paragraph 1 or 2, wherein R¹ is a disaccharide group prepared from sucrose, lactose, maltose, or isomers thereof.

6. The method according to paragraph 1, wherein the saccharide-based monoester comprises one or more sorbitan monoesters, and wherein the sorbitan monoester comprises one or more esters having the chemical formula:

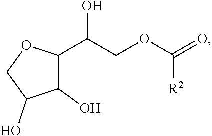

wherein R² is a C15 to C18 chain having 1 to 4 unsaturated bonds.

7. The method according to any one of paragraphs 1 to 6, wherein the purified phosphate material is about 85 wt % to about 99.9 wt % of a total phosphate material contained in the phosphorous ore.

8. The method according to any one of paragraphs 1 to 6, wherein the purified phosphate material is about 90 wt % to about 99.9 wt % of a total phosphate material contained in the phosphorous ore.

9. The method according to any one of paragraphs 1 to 6, wherein the purified phosphate material is about 95 wt % to about 99.9 wt % of a total phosphate material contained in the phosphorous ore.

10. The method according to any one of paragraphs 6 to 9, further comprising combining the tall oil and the sorbitan monoester to produce a tall oil-sorbitan ester collector; and combining the tall oil-sorbitan ester collector and the phosphorous ore to produce the aqueous mixture.

11. The method according to paragraph 10, wherein the tall oil-sorbitan ester collector comprises about 80 wt % to about 99.5 wt % of the tall oil and about 0.5 wt % to about 25 wt % of the sorbitan monoester, based on the combined weight of the tall oil and the sorbitan monoester.

12. The method according to paragraph 10, wherein the aqueous mixture comprises about 0.01 wt % to about 5 wt % of the tall oil-sorbitan ester collector, based on the weight of the phosphorous ore.

13. The method according to paragraph 11, wherein the aqueous mixture comprises about 0.05 wt % to about 0.5 wt % of the tall oil-sorbitan ester collector, based on the weight of the phosphorous ore.

14. A method for purifying a phosphorous containing material, comprising combining a tall oil and a sorbitan monoester to produce a tall oil-sorbitan ester collector, wherein the sorbitan monoester comprises one or more esters having the chemical formula:

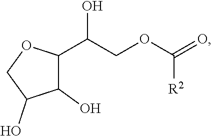

wherein R² is a C15 to C18 chain having 1 to 4 unsaturated bonds, combining the tall oil-sorbitan ester collector and a phosphorous ore to produce an aqueous mixture, and collecting a purified phosphate material from the aqueous mixture.

15. The method according to paragraph 14, wherein the purified phosphate material is about 85 wt % to about 99.9 wt % of a total phosphate material contained in the phosphorous ore.

16. The method according to paragraph 14, wherein the tall oil-sorbitan ester collector comprises about 0.5 wt % to about 25 wt % of the sorbitan monoester and about 80 wt % to about 99.5 wt % of the tall oil, based on the combined weight of the tall oil and the sorbitan monoester.

17. The method according to paragraph 14, wherein the aqueous mixture comprises about 0.05 wt % to about 0.5 wt % of the tall oil-sorbitan ester collector, based on the weight of the phosphorous ore, and wherein the sorbitan monoester comprises sorbitan monooleate, sorbitan monolinoleate, sorbitan monolinolenate, sorbitan monopalmitate, or any mixture thereof.

18. The method according to any one of paragraphs 1 to 17, wherein R² is a C15 to C17 chain having 1 to 3 unsaturated bonds.

19. The method according to any one of paragraphs 14 to 18, wherein the sorbitan monoester comprises sorbitan monooleate, sorbitan monolinoleate, sorbitan monolinolenate, sorbitan monopalmitate, or any mixture thereof.

20. The method according to any one of paragraphs 14 to 19, wherein the sorbitan monoester comprises about 40 wt % to about 99 wt % of sorbitan monooleate and about 1 wt % to about 60 wt % of sorbitan monolinoleate, sorbitan monolinolenate, sorbitan monopalmitate, or any mixture thereof.

21. The method according to any one of paragraphs 14 to 20, further comprising agitating the aqueous mixture by passing gas bubbles or air bubble through the aqueous mixture, mechanically stirring, shaking, or moving the aqueous mixture, sonicating the aqueous mixture, or any combination thereof, and wherein the aqueous mixture is an aqueous solution, a suspension, or a dispersion.

22. The method according to any one of paragraphs 14 to 21, further comprising collecting a tail material from in the aqueous mixture, and wherein the tail material comprises acid insolubles; or wherein the tall oil comprises a crude tall oil, wherein the purified phosphate material comprises tribasic phosphate salts, and wherein the tribasic phosphate salts comprise alkaline earth metals, alkali metals, or mixtures thereof.

23. The method according to any one of paragraphs 14 to 22, wherein the aqueous mixture comprises about 0.1 wt % to about 0.6 wt % of the tall oil and about 0.003 wt % to about 0.054 wt % of the sorbitan monoester, based on the weight of the phosphorous ore.

24. The method according to any one of paragraphs 14 to 23, wherein the sorbitan monoester comprises sorbitan monooleate, wherein the aqueous mixture comprises about 0.2 wt % to about 0.4 wt % of the tall oil and about 0.005 wt % to about 0.03 wt % of the sorbitan monoester, based on the weight of the phosphorous ore, and wherein the purified phosphate material is about 98 wt % to about 99.9 wt % of a total phosphate material contained in the phosphorous ore.

25. A composition of an aqueous mixture of a phosphorous containing material, comprising a phosphorous ore, water, a tall oil, and a sorbitan monoester, wherein the sorbitan monoester comprises one or more esters having the chemical formula:

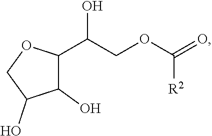

wherein R² is a C15 to C18 chain having 1 to 4 unsaturated bonds.

26. The composition according to paragraph 25, wherein the phosphorous ore comprises phosphate materials, wherein R² is a C15 to C17 chain having 1 to 3 unsaturated bonds, and wherein the aqueous mixture comprises about 0.1 wt % to about 0.6 wt % of the tall oil and about 0.003 wt % to about 0.054 wt % of the sorbitan monoester, based on the weight of the phosphorous ore.

27. The composition according to paragraph 25 or 26, wherein the aqueous mixture comprises about 80 wt % to about 99.5 wt % of the tall oil and about 0.5 wt % to about 25 wt % of the sorbitan monoester, based on the combined weight of the tall oil and the sorbitan monoester.

28. The composition according to any one of paragraphs 25 to 27, wherein the aqueous mixture comprises about 0.01 wt % to about 5 wt % of a tall oil-sorbitan ester collector, based on the weight of the phosphorous ore.

29. The composition according to paragraph 28, wherein the aqueous mixture comprises about 0.05 wt % to about 0.5 wt % of a tall oil-sorbitan ester collector, based on the weight of the phosphorous ore.

30. The composition according to any one of paragraphs 25 to 29, wherein R² is a C15 to C17 chain having 1 to 3 unsaturated bonds.

31. The composition according to any one of paragraphs 25 to 30, wherein the sorbitan monoester comprises sorbitan monooleate, sorbitan monolinoleate, sorbitan monolinolenate, sorbitan monopalmitate, or any mixture thereof.

32. The composition according to any one of paragraphs 25 to 31, wherein the sorbitan monoester comprises about 40 wt % to about 99 wt % of sorbitan monooleate and about 1 wt % to about 60 wt % of sorbitan monolinoleate, sorbitan monolinolenate, sorbitan monopalmitate, or any mixture thereof.

33. The composition according to any one of paragraphs 25 to 32, wherein the tall oil comprises a crude tall oil.

34. The composition according to any one of paragraphs 25 to 33, wherein the purified phosphate material comprises tribasic phosphate salts.

35. The composition according to any one of paragraphs 25 to 34, wherein the tribasic phosphate salts comprise alkaline earth metals, alkali metals, or mixtures thereof.

36. The composition according to any one of paragraphs 25 to 35, wherein the aqueous mixture comprises about 0.1 wt % to about 0.6 wt % of the tall oil and about 0.003 wt % to about 0.054 wt % of the sorbitan monoester, based on the weight of the phosphorous ore.

37. The composition according to any one of paragraphs 25 to 36, wherein the sorbitan monoester comprises sorbitan monooleate, wherein the aqueous mixture comprises about 0.2 wt % to about 0.4 wt % of the tall oil and about 0.005 wt % to about 0.03 wt % of the sorbitan monoester, based on the weight of the phosphorous ore, and wherein the purified phosphate material is about 98 wt % to about 99.9 wt % of a total phosphate material contained in the phosphorous ore.

38. A composition of a tall oil-sorbitan ester collector, comprising a tall oil, and a sorbitan monoester, wherein the sorbitan monoester comprises one or more esters having the chemical formula:

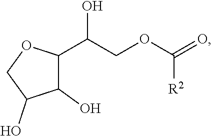

wherein R² is a C15 to C18 chain having 1 to 4 unsaturated bonds.

39. The composition according to paragraph 38, wherein R² is a C15 to C17 chain having 1 to 3 unsaturated bonds.

40. The composition according to paragraph 38 or 39, wherein the tall oil-sorbitan ester collector comprises about 80 wt % to about 99.5 wt % of the tall oil and about 0.5 wt % to about 25 wt % of the sorbitan monoester, based on the combined weight of the tall oil and the sorbitan monoester.

41. The composition according to any one of paragraphs 38 to 40, wherein R² is a C15 to C17 chain having 1 to 3 unsaturated bonds.

42. The composition of any one of paragraphs 38 to 41, wherein the sorbitan monoester comprises sorbitan monooleate, sorbitan monolinoleate, sorbitan monolinolenate, sorbitan monopalmitate, or any mixture thereof.

43. The composition according to any one of paragraphs 38 to 42, wherein the sorbitan monoester comprises about 40 wt % to about 99 wt % of sorbitan monooleate and about 1 wt % to about 60 wt % of sorbitan monolinoleate, sorbitan monolinolenate, sorbitan monopalmitate, or any mixture thereof.

44. The composition according to any one of paragraphs 38 to 42, wherein the sorbitan monoester comprises about 40 wt % to about 99 wt % of sorbitan monooleate.

45. A composition of an aqueous mixture of a phosphorous containing material, comprising a phosphorous ore, water, a tall oil, and a saccharide-based monoester, wherein the saccharide-based monoester comprises one or more esters having the chemical formula:

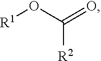

wherein R¹ is a saccharide group having 1 to 14 hydroxyl groups, and R² is a C9 to C24 chain having 1 to 5 unsaturated bonds.

46. The composition according to paragraph 45, wherein R¹ is a monosaccharide group having 1 to 8 hydroxyl groups.

47. The composition according to paragraph 45, wherein R¹ is a monosaccharide group prepared from fructose, galactose, glucose, mannose, ribose, sorbose, xylose, or isomers thereof.

48. The composition according to paragraph 45, wherein R¹ is a disaccharide group having 1 to 10 hydroxyl groups.

49. The composition according to paragraph 45, wherein R¹ is a disaccharide group prepared from sucrose, lactose, maltose, or isomers thereof.

50. The composition according to any one of paragraphs 45 to 49, wherein the phosphorous ore comprises phosphate materials, wherein R¹ is a monosaccharide group having 1 to 8 hydroxyl groups, and wherein the aqueous mixture comprises about 0.1 wt % to about 0.6 wt % of the tall oil and about 0.003 wt % to about 0.054 wt % of the saccharide-based monoester, based on the weight of the phosphorous ore.

51. The composition according to any one of paragraphs 45-50, wherein the aqueous mixture comprises about 80 wt % to about 99.5 wt % of the tall oil and about 0.5 wt % to about 25 wt % of the saccharide-based monoester, based on the combined weight of the tall oil and the saccharide-based monoester.

52. The composition according to any one of paragraphs 45 to 51, wherein the aqueous mixture comprises about 0.01 wt % to about 5 wt % of a tall oil saccharide-based monoester collector, based on the weight of the phosphorous ore.

53. The composition according to paragraph 52, wherein the aqueous mixture comprises about 0.05 wt % to about 0.5 wt % of the tall oil saccharide-based monoester collector, based on the weight of the phosphorous ore.

54. The composition according to any one of paragraphs 45 to 53, wherein the tall oil comprises a crude tall oil.

55. The composition according to any one of paragraphs 45 to 54, wherein the purified phosphate material comprises tribasic phosphate salts.

56. The composition according to any one of paragraphs 45 to 55, wherein the tribasic phosphate salts comprise alkaline earth metals, alkali metals, or mixtures thereof.

57. The composition according to any one of paragraphs 45 to 56, wherein the aqueous mixture comprises about 0.1 wt % to about 0.6 wt % of the tall oil and about 0.003 wt % to about 0.054 wt % of the saccharide-based monoester, based on the weight of the phosphorous ore.

58. A composition of a tall oil saccharide-based monoester collector, comprising a tall oil, and saccharide-based monoester, wherein the saccharide-based monoester comprises one or more esters having the chemical formula:

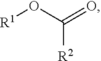

wherein R¹ is a saccharide group having 1 to 14 hydroxyl groups, and R² is a C9 to C24 chain having 1 to 5 unsaturated bonds.

59. The composition according to paragraph 58, wherein R¹ is a monosaccharide group having 1 to 8 hydroxyl groups.

60. The composition according to paragraph 58, wherein R¹ is a monosaccharide group prepared from fructose, galactose, glucose, mannose, ribose, sorbose, xylose, or isomers thereof.

61. The composition according to paragraph 58, wherein R¹ is a disaccharide group having 1 to 10 hydroxyl groups.

62. The composition according to paragraph 58, wherein R¹ is a disaccharide group prepared from sucrose, lactose, maltose, or isomers thereof.

63. The composition according to any one of paragraphs 58 to 62, wherein the tall oil saccharide-based monoester collector comprises about 80 wt % to about 99.5 wt % of the tall oil and about 0.5 wt % to about 25 wt % of the saccharide-based monoester, based on the combined weight of the tall oil and the saccharide-based monoester.

64. A composition, comprising: a tall oil and a saccharide-based monoester having the chemical formula:

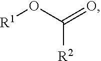

wherein: R¹ is a saccharide group having 1 to 14 hydroxyl groups, and R² is a C9 to C24 chain having 1 to 5 unsaturated bonds.

65. The composition according to paragraph 64, wherein the composition comprises about 80 wt % to about 99.5 wt % of the tall oil and about 0.5 wt % to about 20 wt % of the saccharide-based monoester, based on a combined weight of the tall oil and the saccharide-based monoester.

66. The composition according to paragraph 64 or 65, wherein R¹ is a monosaccharide group having 1 to 8 hydroxyl groups.

67. The composition according to any one of paragraphs 64 to 66, wherein R¹ is a monosaccharide group prepared from fructose, galactose, glucose, mannose, ribose, sorbose, xylose, or isomers thereof.

68. The composition according to any one of paragraphs 64 to 67, wherein R¹ is a disaccharide group having 1 to 10 hydroxyl groups.

69. The composition according to any one of paragraphs 64 to 68, wherein R¹ is a disaccharide group prepared from sucrose, lactose, maltose, or isomers thereof.

70. The composition according to any one of paragraphs 64 to 69, wherein R² is a C15 to C18 chain having 1 to 4 unsaturated bonds.

71. The composition according to any one of paragraphs 64 to 70, wherein the saccharide-based monoester comprises sorbitan monooleate, sorbitan monolinoleate, sorbitan monolinolenate, sorbitan monopalmitate, or any mixture thereof.

72. The composition according to any one of paragraphs 64 to 71, wherein the tall oil comprises a crude tall oil, a distilled tall oil, a tall oil pitch, a tall oil fatty acids, or any mixture thereof.

73. The composition according to any one of paragraphs 64 to 72, wherein: the tall oil comprises crude tall oil, the saccharide-based monoester comprises sorbitan monooleate, sorbitan monolinoleate, sorbitan monolinolenate, sorbitan monopalmitate, or any mixture thereof, and the collector comprises about 90 wt % to about 99 wt % of the tall oil and about 1 wt % to about 10 wt % of the saccharide-based monoester, based on a combined weight of the tall oil and the saccharide-based monoester.

74. The composition according to any one of paragraphs 64 to 73, wherein the saccharide-based monoester comprises one or more sorbitan monoesters.

75. The composition according to any one of paragraphs 64 to 74, wherein the saccharide-based monoester comprises one or more esters having the chemical formula:

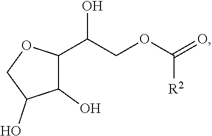

wherein R² is a C15 to C18 chain having 1 to 4 unsaturated bonds.

76. The composition according to any one of paragraphs 64 to 75, wherein R² is a C15 to C17 chain having 1 to 3 unsaturated bonds.

77. The composition according to any one of paragraphs 64 to 76, wherein the saccharide-based monoester comprises about 40 wt % to about 99 wt % of sorbitan monooleate and about 1 wt % to about 60 wt % of sorbitan monolinoleate, sorbitan monolinolenate, sorbitan monopalmitate, or any mixture thereof.

78. An aqueous mixture, comprising: an ore; water; a tall oil; and a saccharide-based monoester having the chemical formula:

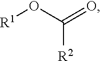

wherein: R¹ is a saccharide group having 1 to 14 hydroxyl groups, and R² is a C9 to C24 chain having 1 to 5 unsaturated bonds.

79. The aqueous mixture according to paragraph 78, wherein the aqueous mixture comprises about 80 wt % to about 99.5 wt % of the tall oil and about 0.5 wt % to about 20 wt % of the saccharide-based monoester, based on a combined weight of the tall oil and the saccharide-based monoester.

80. The aqueous mixture according to paragraph 78 or 79, wherein the aqueous mixture comprises about 0.1 wt % to about 0.6 wt % of the tall oil and about 0.003 wt % to about 0.054 wt % of the saccharide-based monoester, based on the weight of the ore.

81. The aqueous mixture according to any one of paragraphs 78 to 80, wherein the saccharide-based monoester comprises sorbitan monooleate, sorbitan monolinoleate, sorbitan monolinolenate, sorbitan monopalmitate, or any mixture thereof.

82. The aqueous mixture according to any one of paragraphs 78 to 81, wherein the tall oil comprises a crude tall oil, a distilled tall oil, a tall oil pitch, a tall oil fatty acids, or any mixture thereof.

83. The aqueous mixture according to any one of paragraphs 78 to 82, wherein the ore is a phosphorous ore.

84. The aqueous mixture according to any one of paragraphs 78 to 83, wherein the aqueous mixture comprises about 90 wt % to about 99 wt % of the tall oil and about 1 wt % to about 10 wt % of the saccharide-based monoester, based on a combined weight of the tall oil and the saccharide-based monoester.

85. The aqueous mixture according to any one of paragraphs 78 to 84, wherein the aqueous mixture comprises about 0.1 wt % to about 0.6 wt % of the tall oil and about 0.003 wt % to about 0.054 wt % of the saccharide-based monoester, based on the weight of the ore.

86. A method for purifying an ore containing material, comprising: combining an ore, water, a tall oil, and a saccharide-based monoester to produce an aqueous mixture, wherein the saccharide-based monoester has the chemical formula:

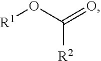

wherein: R¹ is a saccharide group having 1 to 14 hydroxyl groups, and R² is a C9 to C24 chain having 1 to 5 unsaturated bonds; and collecting a purified ore from the aqueous mixture.

87. The method according to paragraph 86, wherein the tall oil comprises crude tall oil.

88. The method according to paragraph 86 or 87, wherein the saccharide-based monoester comprises sorbitan monooleate, sorbitan monolinoleate, sorbitan monolinolenate, sorbitan monopalmitate, or any mixture thereof.

89. The method according to any one of paragraphs 86 to 88, wherein the aqueous mixture comprises about 80 wt % to about 99 wt % of the tall oil and about 1 wt % to about 20 wt % of the saccharide-based monoester, based on a combined weight of the tall oil and the saccharide-based monoester.

90. The method according to any one of paragraphs 86 to 89, further comprising agitating the aqueous mixture by passing gas bubbles through the aqueous mixture, mechanically stirring, shaking, or moving the aqueous mixture, sonicating the aqueous mixture, or any combination thereof.

91. The method according to any one of paragraphs 86 to 90, wherein the aqueous mixture is an aqueous solution, a suspension, or a dispersion.

92. The method according to any one of paragraphs 86 to 88, 90, or 81, wherein the aqueous mixture comprises about 90 wt % to about 99 wt % of the tall oil and about 1 wt % to about 10 wt % of the saccharide-based monoester, based on a combined weight of the tall oil and the saccharide-based monoester.

93. The method according to any one of paragraphs 86 to 92, wherein the ore is a phosphorous ore.

94. The method according to any one of paragraphs 86 to 93, wherein the purified ore comprises a purified phosphate material.

95. The method according to paragraph 94, wherein the purified phosphate material is about 85 wt % to about 99.9 wt % of a total phosphate material contained in the phosphorous ore.

96. The method according to any one of paragraphs 86 to 95, wherein the ore is a phosphorous ore.

97. The method according to any one of paragraphs 86 to 95, further comprising passing air through the aqueous mixture to provide a relatively hydrophobic fraction and a relatively hydrophilic fraction, wherein the purified ore is collected from the hydrophilic fraction.

98. The method according to paragraph 96, wherein the ore is a phosphorous ore.

99. The method according to any one of paragraphs 86 to 95, further comprising passing air through the aqueous mixture to provide a relatively hydrophobic fraction and a relatively hydrophilic fraction, wherein the purified ore is collected from the hydrophobic fraction.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments, other and further embodiments of the invention can be devised without departing from the basic scope thereof, and the scope thereof is determined by the claims that follow.

What is claimed is:

1. A composition, comprising:
a tall oil; and
a saccharide-based monoester having the chemical formula: 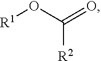
wherein:
R¹ is a saccharide group having 1 to 14 hydroxyl groups, and
R² is a C9 to C24 chain having 1 to 5 unsaturated bonds.

2. The composition of claim 1, wherein the collector comprises about 80 wt % to about 99.5 wt % of the tall oil and about 0.5 wt % to about 20 wt % of the saccharide-based monoester, based on a combined weight of the tall oil and the saccharide-based monoester.

3. The composition of claim 1, wherein R¹ is a monosaccharide group having 1 to 8 hydroxyl groups.

4. The composition of claim 1, wherein R¹ is a monosaccharide group prepared from fructose, galactose, glucose, mannose, ribose, sorbose, xylose, or isomers thereof.

5. The composition of claim 1, wherein R¹ is a disaccharide group having 1 to 10 hydroxyl groups.

6. The composition of claim 1, wherein R¹ is a disaccharide group prepared from sucrose, lactose, maltose, or isomers thereof.

7. The composition of claim 1, wherein R² is a C15 to C18 chain having 1 to 4 unsaturated bonds.

8. The composition of claim 1, wherein the saccharide-based monoester comprises sorbitan monooleate, sorbitan monolinoleate, sorbitan monolinolenate, sorbitan monopalmitate, or any mixture thereof.

9. The composition of claim 1, wherein the tall oil comprises a crude tall oil, a distilled tall oil, a tall oil pitch, a tall oil fatty acids, or any mixture thereof.

10. The composition of claim 1, wherein:
the tall oil comprises crude tall oil,
the saccharide-based monoester comprises sorbitan monooleate, sorbitan monolinoleate, sorbitan monolinolenate, sorbitan monopalmitate, or any mixture thereof, and
the collector comprises about 90 wt % to about 99 wt % of the tall oil and about 1 wt % to about 10 wt % of the saccharide-based monoester, based on a combined weight of the tall oil and the saccharide-based monoester.

11. An aqueous mixture, comprising:
an ore;
water;
a tall oil; and
a saccharide-based monoester having the chemical formula: 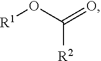
wherein:
R¹ is a saccharide group having 1 to 14 hydroxyl groups, and
R² is a C9 to C24 chain having 1 to 5 unsaturated bonds.

12. The aqueous mixture of claim 11, wherein the aqueous mixture comprises about 80 wt % to about 99.5 wt % of the tall oil and about 0.5 wt % to about 20 wt % of the saccharide-based monoester, based on a combined weight of the tall oil and the saccharide-based monoester.

13. The aqueous mixture of claim 11, wherein the aqueous mixture comprises about 0.1 wt % to about 0.6 wt % of the tall oil and about 0.003 wt % to about 0.054 wt % of the saccharide-based monoester, based on the weight of the ore.

14. The aqueous mixture of claim 11, wherein the saccharide-based monoester comprises sorbitan monooleate, sorbitan monolinoleate, sorbitan monolinolenate, sorbitan monopalmitate, or any mixture thereof.

15. The aqueous mixture of claim 11, wherein the tall oil comprises a crude tall oil, a distilled tall oil, a tall oil pitch, a tall oil fatty acids, or any mixture thereof.

16. The aqueous mixture of claim 11, wherein the ore is a phosphorous ore.

17. The aqueous mixture of claim 11, wherein:
the ore is a phosphorous ore,
the tall oil comprises crude tall oil,
the saccharide-based monoester comprises sorbitan monooleate, sorbitan monolinoleate, sorbitan monolinolenate, sorbitan monopalmitate, or any mixture thereof,
the aqueous mixture comprises about 90 wt % to about 99 wt % of the tall oil and about 1 wt % to about 10 wt % of the saccharide-based monoester, based on a combined weight of the tall oil and the saccharide-based monoester, and
the aqueous mixture comprises about 0.1 wt % to about 0.6 wt % of the tall oil and about 0.003 wt % to about 0.054 wt % of the saccharide-based monoester, based on the weight of the ore.

18. A method for purifying an ore, comprising:
combining an ore, water, a tall oil, and a saccharide-based monoester to produce an aqueous mixture, wherein the saccharide-based monoester has the chemical formula: 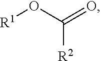
wherein:
R¹ is a saccharide group having 1 to 14 hydroxyl groups, and
R² is a C9 to C24 chain having 1 to 5 unsaturated bonds; and
collecting a purified ore from the aqueous mixture.

19. The method of claim 18, further comprising passing air through the aqueous mixture to provide a relatively hydrophobic fraction and a relatively hydrophilic fraction, wherein:
the tall oil comprises crude tall oil,
the saccharide-based monoester comprises sorbitan monooleate, sorbitan monolinoleate, sorbitan monolinolenate, sorbitan monopalmitate, or any mixture thereof,
the aqueous mixture comprises about 80 wt % to about 99 wt % of the tall oil and about 1 wt % to about 20 wt % of the saccharide-based monoester, based on a combined weight of the tall oil and the saccharide-based monoester, and
the purified ore is collected from the hydrophilic fraction.

20. The method of claim 18, further comprising agitating the aqueous mixture by passing gas bubbles through the aqueous mixture, mechanically stirring, shaking, or moving the aqueous mixture, sonicating the aqueous mixture, or any combination thereof, wherein:
the aqueous mixture is an aqueous solution, a suspension, or a dispersion,
the aqueous mixture comprises about 90 wt % to about 99 wt % of the tall oil and about 1 wt % to about 10 wt % of the saccharide-based monoester, based on a combined weight of the tall oil and the saccharide-based monoester,
the ore is a phosphorous ore,
the purified ore comprises a purified phosphate material, and
the purified phosphate material is about 85 wt % to about 99.9 wt % of a total phosphate material contained in the phosphorous ore.
